(19) United States
(12) Patent Application Publication
(10) Pub. No.: US 2023/0177516 A1
(43) Pub. Date: Jun. 8, 2023

(54) CALCULATING, FORECASTING, AND/OR PLANNING QUALIFIED PIPELINE ALONG ONE OR MORE DIMENSIONS FROM LIMITED DATA

(71) Applicant: 6SENSE INSIGHTS, INC., San Francisco, CA (US)

(72) Inventors: Yongqiang He, Freemont, CA (US); Rahul Sachdev, Burlingame, CA (US); Nimish Mehta, Los Altos Hills, CA (US); Parameswaran Viswanathan, San Jose, CA (US); Hon Ming Yeung, Redwood City, CA (US); Amit Patel, San Ramon, CA (US); Daniel LaPushin, San Francisco, CA (US)

(21) Appl. No.: 18/075,229

(22) Filed: Dec. 5, 2022

Related U.S. Application Data
(60) Provisional application No. 63/286,449, filed on Dec. 6, 2021.
(60) Provisional application No. 63/286,453, filed on Dec. 6, 2021.
(60) Provisional application No. 63/286,456, filed on Dec. 6, 2021.

(51) Int. Cl. G06Q 30/015

(52) U.S. Cl. CPC G06Q 30/015

(57) ABSTRACT

Conventional customer relationship management (CRM) systems provide limited data that are not conducive to the calculation of the qualified portion of a sales pipeline. Accordingly, embodiments calculate a metric of qualified pipeline from this limited data, and can do so across one or a plurality of various dimensions. In addition, embodiments can forecast the metric of qualified pipeline at a future time and/or derive a pipeline plan based on a future booking target.

### CROSS-REFERENCE TO RELATED APPLICATIONS

This application claims priority to U.S. Provisional Patent App. No. 63/286,449, filed on Dec. 6, 2021, U.S. Provisional Patent App. No. 63/286,453, filed on Dec. 6, 2021, and U.S. Provisional Patent App. No. 63/286,456, filed on Dec. 6, 2021, which are all hereby incorporated herein by reference as if set forth in their entireties.

### BACKGROUND

### Field of the Invention

The embodiments described herein are generally directed to qualified pipeline, and, more particularly, to calculating, forecasting, and/or planning qualified pipeline, along one or more dimensions, from limited data.

### Description of the Related Art

“Business-to-business” (B2B) refers to the business of selling a product (e.g., a good or service) to another business. B2B marketers and demand-generation teams are increasingly required to move beyond content creation and lead production to revenue generation. A key component in measuring the revenue performance of marketing is the sales pipeline.

The term “sales pipeline” refers to the stages that a sales representative goes through to convert an opportunity into a customer. Stages in a typical sales pipeline include creation of an opportunity, product demonstration, qualification of the opportunity, sales proposal, negotiation, closed-won (e.g., the opportunity was closed with a sale, i.e., won), closed-lost (e.g., the opportunity was closed without a sale, i.e., lost), and/or the like. The sales pipeline is closely related to the “sales funnel,” which refers to the actions that customers take from awareness of a product to purchase of the product. Pipeline marketing is a strategy that is focused on selling a product (e.g., good or service) to a particular entity (e.g., company or person) in an individualized manner that typically concentrates on the narrow or bottom portion of the sales funnel. Pipeline marketing generally involves setting targets and evaluating critical metrics that are relevant to achieving those targets.

One critical metric that may be evaluated in pipeline marketing is the “qualified pipeline.” The qualified pipeline is a measure of sales opportunities (e.g., sum of monetary values, average monetary value, number of opportunities, etc.) in a customer relationship management (CRM) system that have been accepted as actual deals with defined monetary values and specific closing dates. The value of the qualified pipeline is a critical metric for connecting demand-generation efforts with sales bookings. Since B2B sales cycles are long, typically lasting weeks or months and requiring several “touches” of a lead to push the lead through the sales funnel, timely generation of the qualified pipeline is important.

However, due to their inherent designs, CRM systems make it difficult to measure the qualified pipeline at a point in time. For example, it is challenging to maintain the notion of stage progression through the sales pipeline in most CRM systems. Sales definitions can also change over time. Thus, there is usually no easy way to determine when a sales opportunity has become qualified, such that it should be included in the qualified pipeline.

It is even more challenging to accurately measure the qualified pipeline along one or more other dimensions, such as the go-to-market (GTM) segment, from existing CRM systems. A GTM segment is a business unit of an organization, segregated by one or more characteristics, such as size, revenue, geography, industry, and/or the like.

It is also challenging to accurately forecast the qualified pipeline along one or more dimensions. Forecasting refers to predicting the value of qualified pipeline that is likely to be generated in the future.

It is even more challenging to accurately determine a pipeline plan. A pipeline plan refers to how much qualified pipeline must be generated along one or more dimensions (e.g., GTM segment and product in a specified time period) to achieve a target. For example, the inputs required to calculate the pipeline plan may differ for each GTM segment and change frequently.

In summary, given the limited data in existing CRM systems, it is difficult to calculate, forecast, and/or plan qualified pipeline along one or more dimensions.

### SUMMARY

Accordingly, systems, methods, and non-transitory computer-readable media are disclosed for calculating, forecasting, and/or planning qualified pipeline, along one or more dimensions, based on the limited data that are typically available. For example, disclosed embodiments may measure and utilize various parameters related to a qualified pipeline, including the value of the qualified pipeline at a given point in time, the value of the qualified pipeline for each GTM segment, a forecast of the qualified pipeline, and/or a pipeline plan. These embodiments can create meaning on top of the data available from a CRM system and/or other sources.

In an embodiment, a method comprises using at least one hardware processor to: set a qualifying stage that divides a pipeline, comprising a plurality of stages, into an unqualified pipeline and a qualified pipeline; set one or more times; for each of the one or more times, determine a set of opportunities that had reached the qualifying stage at that time, calculate a metric of the qualified pipeline based on the determined set of opportunities, and store the calculated metric in memory; and perform one or more actions based on at least one of the stored calculated metrics.

Any opportunities, which reached the qualifying stage at the time but are currently in the unqualified pipeline, may be excluded from the set of opportunities.

The one or more times may be a plurality of times. The plurality of times may comprise a plurality of times that are separated by fixed time intervals.

The plurality of times may represent one or more fiscal periods. The one or more fiscal periods may be a plurality of fiscal periods that comprise at least one first fiscal period at a first level of granularity and a plurality of second fiscal periods at a second level of granularity that has greater granularity than the first level, wherein the at least one first fiscal period is composed of the plurality of second fiscal periods, wherein the one or more actions comprise generating a graphical user interface that comprises a first screen and a second screen, wherein the first screen visually represents the stored calculated metric for the at least one fiscal period and provides navigation to the second screen, and wherein the second screen visually represents the stored calculated metric for each of the plurality of second fiscal periods. The at least one first fiscal period may extend to a future time, such that at least one of the plurality of second fiscal periods also extends to the future time, and the method may further comprise using the at least one hardware processor to forecast the metric of the qualified pipeline at the future time, and the first screen and the second screen may visually represent the forecasted metric of the qualified pipeline at the future time. Forecasting the metric of the qualified pipeline at the future time may comprise calculating a minimum value of the metric of the qualified pipeline at the future time and a maximum value of the metric of the qualified pipeline at the future time, and the first screen and the second screen may visually represent a range between the minimum value and the maximum value.

The method may further comprise using the at least one hardware processor to receive a plurality of opportunities from a customer relationship management (CRM) system via at least one network, wherein the set of opportunities is determined from the received plurality of opportunities. Each of the plurality of opportunities may comprise a set of one or more stages associated with the opportunity, and, for each of the one or more stages, a time at which the opportunity entered that stage, and determining the set of opportunities may comprise, for each of the plurality of opportunities: generating a time series of the one or more stages associated with that opportunity based on the time at which the opportunity entered each of the one or more stages; and determining whether or not the opportunity had reached the qualifying stage at the time based on the time series. Each of the plurality of opportunities may comprise a set of one or more stages associated with the opportunity, and determining the set of opportunities may comprise, for each stage in the set of one or more stages: if the stage is not one of the plurality of stages, map the stage to one of the plurality of stages or to a position in the pipeline based on a stored mapping. The set of opportunities may be stored in a relational database, and calculating the metric of the qualified pipeline may comprise executing a single query that sums an attribute, stored in the relational database, for each opportunity in the set of opportunities. The attribute may be a monetary value. The single query may group the metric by one or more dimensions. The single query may exclude opportunities from the set of opportunities that are associated with a current stage that is in the unqualified pipeline. The metric of the qualified pipeline may comprise one or more of a total monetary value, average monetary value, or count of the determined set of opportunities.

Calculating the metric of the qualified pipeline may comprise calculating the metric of the qualified pipeline in one or more dimensions, other than time. The one or more dimensions may comprise go-to-market segments. The one or more dimensions may comprise products.

The one or more actions may comprise tracking a performance metric of the pipeline.

The performance metric may comprise one or more of an opportunity win rate, a pipeline win rate, or an average sales cycle.

The method may further comprise using the at least one hardware processor to: for each opportunity in the determined set of opportunities for the one or more times, determine a buyer persona associated with the opportunity, wherein the buyer persona comprises a job level and a job function; and order the determined buyer personas based on a frequency of each determined buyer persona within the determined set of opportunities for the one or more times.

The one or more actions may comprise forecasting the metric of the qualified pipeline at a future time.

The one or more times may comprise a current time, and wherein forecasting the metric of the qualified pipeline at a future time comprises: determining a number N of predefined time intervals between the current time and the future time; determining a growth rate G for the predefined time intervals; and calculating the metric of the qualified pipeline at the future time according to

F=G×N+B,

wherein F is the metric of the qualified pipeline at the future time, and wherein B is the calculated metric, stored in memory, for the current time.

Determining the growth rate G may comprise: executing each of a plurality of independent forecasting models that output a value for the growth rate G; and determining a single value for the growth rate G from the values output by the plurality of independent forecasting models.

Determining the growth rate G may comprise: executing each of a plurality of independent forecasting models that output a value for the growth rate G; identifying a minimum value for the growth rate G from the values output by the plurality of independent forecasting models; identifying a maximum value for the growth rate G from the values output by the plurality of independent forecasting models; calculating a base-case value of the metric F of the qualified pipeline at the future time using the minimum value for the growth rate G; and calculating a best-case value of the metric F of the qualified pipeline at the future time using the maximum value for the growth rate G.

Determining the growth rate G may comprise calculating the growth rate G using a seasonal average that calculates an average actual growth rate for the predefined time intervals within a time period, corresponding to a time period between the current time and the future time in a current fiscal year, in one or more prior fiscal years.

Determining the growth rate G may comprise calculating the growth rate G using a moving average that calculates an average actual growth rate for the predefined time intervals within a time period, corresponding to a time period between the current time and the future time in a current fiscal period, in one or more prior fiscal periods.

Determining the growth rate G may comprise calculating the growth rate G using a linear drift that calculates an average actual growth rate for the predefined time intervals within at least one past time period.

The one or more times may comprise a current time, and forecasting the metric of the qualified pipeline at a future time may comprise: determining a number N of predefined time intervals between the current time and the future time; and, for each channel c from a plurality of channels C, determining a growth rate G_{c} for the predefined time intervals for the channel c; determining a growth rate G for the predefined time intervals for the qualified pipeline; and calculating the metric of the qualified pipeline at the future time for the channel c according to

$${F}_{c \_ min} = \frac{min {G}_{c} + max {G}_{c}}{{\sum }_{i = 0}^{C} min {G}_{i} + {\sum }_{i = 0}^{C} max {G}_{i}} \times min ( G \times N ) + {B}_{c}$$

$${F}_{c \_ max} = \frac{min {G}_{c} + max {G}_{c}}{{\sum }_{i = 0}^{C} min {G}_{i} + {\sum }_{i = 0}^{C} max {G}_{i}} \times max ( G \times N ) + {B}_{c}$$

wherein min is a function that finds a minimum value, wherein max is a function that finds a maximum value, wherein F_{c_min} is a minimum value of the qualified pipeline for channel c at the future time, wherein F_{c_max} is a maximum value of the qualified pipeline for channel c at the future time, and wherein B_{c} is the calculated metric, stored in memory, for the current time for channel c.

The one or more actions may comprise generating a pipeline plan for one or more time periods, preceding a future time, for achieving a booking target at the future time. The pipeline plan may comprise a value of the metric of the qualified pipeline.

The pipeline plan may be generated based on the booking target and one or more parameters derived from the at least one stored calculated metric. The one or more parameters may comprise one or more of a win rate, a sales cycle, or an average won opportunity size.

The pipeline plan may be generated based on a planning model that comprises at least one booking model that defines the booking target, at least one assumption model that defines one or more parameters derived from the at least one stored calculated metric, and at least one allocation model that defines a proportion of the metric of the qualified pipeline that is allocated to each of a plurality of sources.

Generating the pipeline plan may comprise calculating the pipeline plan Pₜₚ for a time interval t in a fiscal period p for a source according to:

$${P}_{tp} = \frac{{A}_{tp} \times {R}_{t}}{W}$$

wherein Aₜₚ is an amount of bookings allocated to the source for time interval t in fiscal period p, wherein Rₜ is a tracking ratio, and wherein W is a win rate for the source. The amount of bookings Aₜₚ may be computed as:

$${A}_{tp} = {\sum }_{i , j}^{t , p} ( {FB}_{ij} \times {PR}_{ij} \times {PCT}_{ij} )$$

wherein FBᵢⱼ is a total amount of bookings for time interval i in fiscal period j, wherein PRᵢⱼ is a proportional ratio for time interval i in fiscal period j, and wherein PCTᵢⱼ is a percentage of the total amount of bookings that is allocated to the source for time interval i in fiscal period j.

The proportional ratio PRᵢⱼ may be computed based on a sales cycle between the qualifying stage and one of the plurality of stages representing a closed and won opportunity. The proportional ratio PRᵢⱼ may be computed as:

$$if {SD}_{ij} < {SD}_{tp} + SC \& {ED}_{ij} < {ED}_{tp} + SC , \\ then {PR}_{ij} = \frac{{ED}_{ij} - ( {SD}_{tp} + SC - 1 )}{{ED}_{ij} - {SD}_{ij} + 1} ,$$

$$else if {SD}_{ij} \geq {SD}_{tp} + SC \& {ED}_{ij} \leq {ED}_{tp} + SC , \\ then {PR}_{ij} = 1 ,$$

$$else if {SD}_{ij} \geq {SD}_{tp} + SC \& {ED}_{ij} \geq {ED}_{tp} + SC , \\ then {PR}_{ij} = \frac{( {ED}_{tp} + SC ) - {SD}_{ij} + 1 )}{{ED}_{ij} - {SD}_{ij} + 1} ,$$

wherein SDᵢⱼ is a start date of time interval i in fiscal period j, SDₜₚ is a start date of time interval t in fiscal period p, EDᵢⱼ is an end date of time interval i in fiscal period j, EDₜₚ is an end date of time interval t in fiscal period p, and SC is the sales cycle.

Generating the pipeline plan for one or more time periods may comprise generating the pipeline plan in each of one or more dimensions for each of the one or more time periods. The one or more dimensions may comprise go-to-market segments. The one or more dimensions may comprise products.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIG. 3 illustrates some example data structures and their relationships to each other, according to an embodiment;

FIG. 4 illustrates an example sales pipeline, according to an embodiment;

FIG. 5 illustrates a process for calculating the qualified pipeline, according to an embodiment;

FIG. 6 illustrates an example of a sales funnel, according to an embodiment;

FIG. 7 illustrates an example high-level entity relationship diagram for various data structures used in pipeline planning, according to an embodiment;

FIG. 8 illustrates a process for calculating a pipeline model, according to an embodiment; and

FIGS. 9A-15D illustrate example screens of a graphical user interface that may be utilized with one or more of the processes described herein, according to an embodiment.

### DETAILED DESCRIPTION

In an embodiment, systems, methods, and non-transitory computer-readable media are disclosed for calculating, forecasting, and/or planning qualified pipeline, along one or more dimensions, based on the limited data that are typically available. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. System Overview

### 1.1. Infrastructure

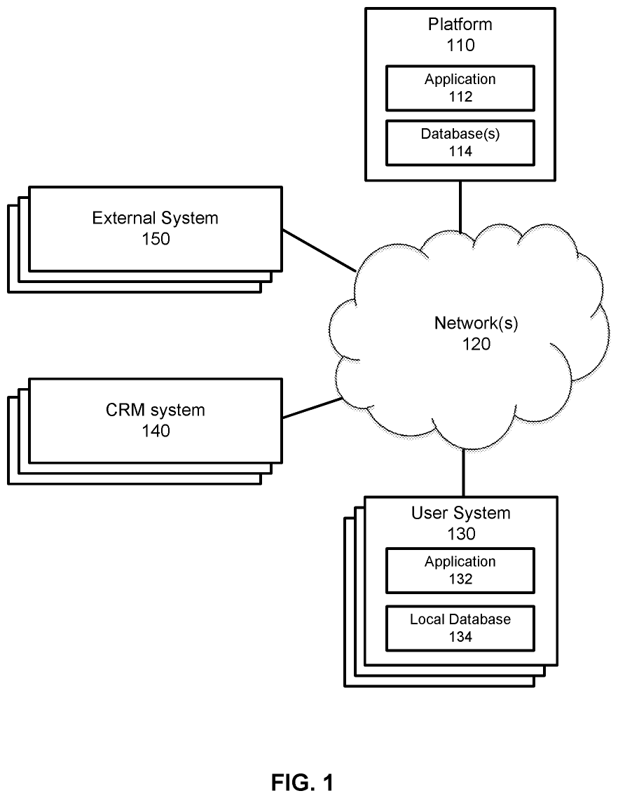

FIG. 1 illustrates an example infrastructure in which one or more of the disclosed processes may be implemented, according to an embodiment. The infrastructure may comprise a platform 110 (e.g., one or more servers) which hosts and/or executes one or more of the various functions, processes, methods, and/or software modules described herein. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more CRM systems 140 (e.g., software applications executing on platform 110 or another platform) and/or one or more external systems 140 (e.g., other platforms, websites, etc.) via network(s) 120.

Network(s) 120 may comprise the Internet, and platform 110 may communicate with user system(s) 130, CRM systems 140, and/or external systems 150 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130, CRM systems 140, and/or external systems 150 via the Internet, but may be connected to one or more other user systems 130, CRM systems 140, and/or external systems 150 via an intranet. Furthermore, while only a few user systems 130, CRM systems 140, and external systems 150, one server application 112, and one set of database(s) 114 are illustrated, it should be understood that the infrastructure may comprise any number of user systems, CRM systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that user systems 130 would comprise the personal computers and/or workstations of agents (e.g., marketing or sales representatives, financial analysts, data scientists, etc.) of businesses (e.g., B2B businesses). Each user system 130 may comprise or be communicatively connected to a client application 132 and/or one or more local databases 134 that stored data used by client application 132.

CRM systems 140 may also comprise any type or types of computing devices capable of wired and/or wireless communication. However, it is generally contemplated that CRM systems 140 would comprise software applications executing on a server system. Examples of such software applications include, without limitation, Salesforce™, HubSpot™, Microsoft Dynamics™, EngageBay™, Salesflare™, and the like. CRM systems 140 may communicate with server application 112 via an application programming interface (API). For example, server application 112 may “pull” data from and/or “push” data to a CRM system 140 via an API provided by the CRM system 140, or a CRM system 140 may “pull” data from and/or “push” data to server application 112 via an API provided by server application 112.

Although CRM systems 140 are illustrated as being external to platform 110, in an alternative embodiment, one or more CRM systems 140 could be hosted on platform 110. In this case, server application 112 may still communicate with a CRM system 140 via an API, but may do so over an internal network of platform 110.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may comprise, be communicatively coupled with, or otherwise have access to one or more database(s) 114. For example, platform 110 may comprise one or more database servers which manage one or more databases 114. Server application 112 executing on platform 110 and/or client application 132 executing on user system 130 may submit data (e.g., user data, form data, etc.) to be stored in database(s) 114, and/or request access to data stored in database(s) 114. Any suitable database may be utilized, including without limitation My SQL™, Oracle™ IBM™, Microsoft SQL™, Access™, PostgreSQL™, MongoDB™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from user system(s) 130, CRM system(s) 140 and/or external system(s) 150, and provide responses in eXtensible Markup Language (XML), JavaScript Object Notation (JSON), and/or any other suitable or desired format. In such embodiments, platform 110 may provide an API which defines the manner in which user system(s) 130, CRM system(s) 140, and/or external system(s) 150 may interact with the web service. Thus, user system(s) 130, CRM system(s) 140, and/or external system(s) 150 (which may themselves be servers), can define their own user interfaces, and rely on the web service to implement or otherwise provide the backend processes, methods, functionality, storage, and/or the like, described herein. For example, in such an embodiment, a client application 132, executing on one or more user system(s) 130, may interact with a server application 112 executing on platform 110 to execute one or more or a portion of one or more of the various functions, processes, methods, and/or software modules described herein.

Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the software described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes, methods, or functions described herein. This software may also be generally referred to herein as “the application.”

### 1.2. Example Processing Device

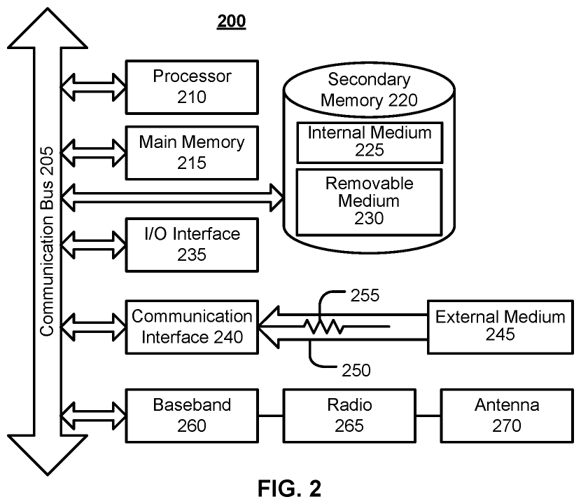

FIG. 2 is a block diagram illustrating an example wired or wireless system 200 that may be used in connection with various embodiments described herein. For example, system 200 may be used as or in conjunction with one or more of the functions, processes, or methods (e.g., to store and/or execute the software) described herein, and may represent components of platform 110, user system(s) 130, CRM system(s) 140, external system(s) 150, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, any of the processors (e.g., Pentium™, Core i7™, Xeon™, etc.) available from Intel Corporation of Santa Clara, Calif., any of the processors available from Advanced Micro Devices, Incorporated (AMD) of Santa Clara, Calif., any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPM), IEEE 696/S-100, and/or the like.

System 200 preferably includes a main memory 215 and may also include a secondary memory 220. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 is a non-transitory computer-readable medium having computer-executable code (e.g., any of the software disclosed herein) and/or other data stored thereon. The computer software or data stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 include an external hard disk drive, an external optical drive, an external magneto-optical drive, and/or the like.

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed software) is stored in main memory 215 and/or secondary memory 220. Computer-executable code can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225 and/or removable medium 230), external storage medium 245, and any peripheral device communicatively coupled with communication interface 240 (including a network information server or other network device). These non-transitory computer-readable media are means for providing software and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 200 may also include optional wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor(s) 210. Processor(s) 210 may have access to data storage areas 215 and 220. Processor(s) 210 are preferably configured to execute instructions (i.e., computer programs, such as the disclosed software) that can be stored in main memory 215 or secondary memory 220. Computer programs can also be received from baseband processor 260 and stored in main memory 210 or in secondary memory 220, or executed upon receipt. Such computer programs, when executed, can enable system 200 to perform the various functions of the disclosed embodiments.

### 1.3. Example Data Structures

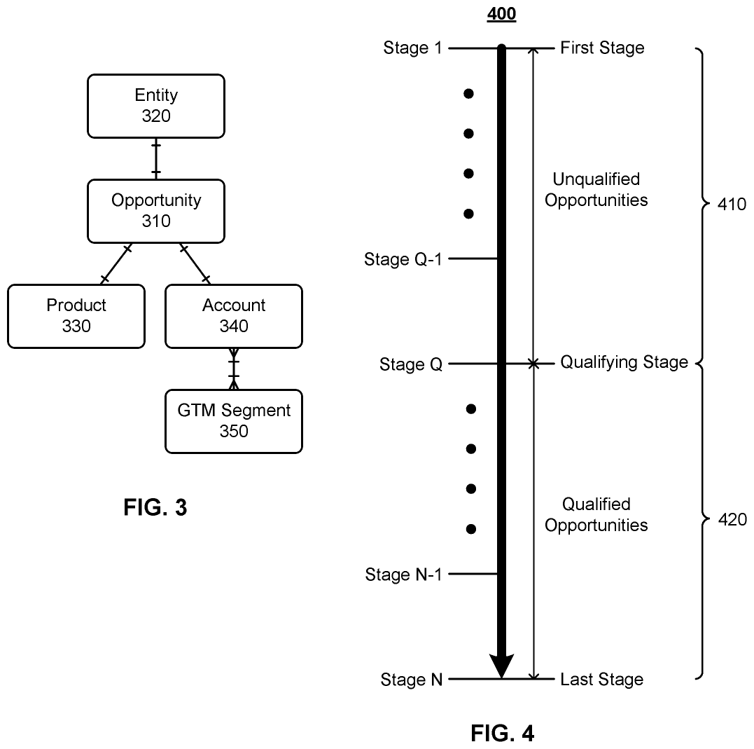

FIG. 3 illustrates some example data structures and their relationships to each other, according to an embodiment. In the illustrated example, a sales opportunity 310 is associated one-to-one with an entity 320, one-to-one with a product 330 and one-to-one with an account 340. Each instance of an entity 320 represents an organizational user of platform 110, such as a B2B business. Each instance of a product 330 represents a product that is sold by an entity 320. Each instance of an account 340 represents a customer (e.g., another business) or potential customer of an entity 320. Accordingly, each instance of an opportunity 310 represents the opportunity for a sale by an entity 320 of a product 330 to an account 340.

Instances of accounts 340 may be associated many-to-many with instances of GTM segments 350. Thus, a single account 340 may be associated with one or a plurality of GTM segments 350, and a single GTM segment 350 may be associated with one or a plurality of accounts 340. Each instance of a GTM segment 350 represents a business unit of an account 340. These business units may be defined in terms of revenue, employees, industry, geography, and/or any other attribute of an account 340. In an embodiment, GTM segments 350 are defined by users (e.g., representing an entity 320). Thus, different users may define different GTM segments 350, for the accounts 340 that they manage, than other users, according to their specific needs or desires. Accounts 340 may be grouped by these user-defined GTM segments 350 (e.g., in database queries, for reporting, etc.).

It should be understood that any of these data structures may represent a dimension, in addition to time, along which the qualified pipeline may be measured by the various processes described herein. In general, it is contemplated that opportunities 310, which have been qualified, would be measured along the dimensions of time, product 330, and GTM segment 350. Entity 320 is contemplated to be an implicit fixed dimension, in that a user, representing an entity 320, will view measures of the qualified pipeline along the dimensions of time, product 330, and GTM segment 350, for his or her specific entity 320. However, it should be understood that the qualified pipeline could be measured across different entities 320 (e.g., by software or a user with permissions across multiple entities 320) to, for example, perform analytics, such as identifying industry-wide patterns, trends, and/or the like. It should also be understood that the described dimensions are simply examples, and that the historical or forecasted qualified pipeline may be measured in all of these dimensions, any subset of these dimensions, any combination of these dimensions or a subset of these dimensions with other dimensions, or an entirely different set of dimensions.

### 1.4. Example Pipeline

FIG. 4 illustrates an example sales pipeline 400, according to an embodiment. In general, pipeline 400 comprises a sequence of N stages, from a first stage (i.e., Stage 1) to a last stage (i.e., Stage N). While pipeline 400 may comprise any number of stages, it is generally contemplated that pipeline 400 will comprise three or more stages (i.e., N≥3).

One stage, illustrated as Stage Q, may be selected as the qualifying stage. The qualifying stage represents the stage in which an opportunity 310 is considered an actual deal. In other words, if an opportunity 310 reaches the qualifying stage or any stage following the qualifying stage (e.g., Stage Q through Stage N), the opportunity 310 has become qualified, and therefore, should be included in the qualified pipeline. Thus, the term “qualified opportunity” refers to any opportunity that has reached, and optionally remains, in the portion of pipeline 400 including and following the qualify stage. This portion of pipeline 400 may be referred to herein as qualified pipeline 420. The qualifying stage may be a stage in which terms have been agreed upon, a contract has been signed, a deposit has been paid, an expected closing date has been established, and/or the like. Opportunities 310 that are in a stage that precedes the qualifying stage (e.g., Stages 1 through Stage Q−1) are unqualified and should be excluded from qualified pipeline 420. This portion of pipeline 400 may be referred to herein as unqualified pipeline 410.

It should be understood that an opportunity 310 does not necessarily have to pass through every stage in pipeline 400. Rather, it is possible for an opportunity 310 to skip one or more stages. For example, an opportunity 310 could proceed directly from Stage 1 to Stage Q, thereby skipping Stage Q−1 and any other stages therebetween. In this case, the opportunity 310 would still be qualified by virtue of it reaching Stage Q, even though the opportunity 310 skipped one or more stages preceding Stage Q. Of course, it also possible for an opportunity 310 to proceed through every stage from Stage 1 to Stage N.

It should be understood that an opportunity 310 may proceed in reverse order in some cases. For example, an opportunity 310 may reach Stage Q, representing an actual deal (e.g., in response to a signed contract), at time T1, but may regress to Stage Q−1 if the deal falls through (e.g., in response to a broken contract) at time T2. In this case, opportunity 310 would be included in qualified pipeline 420 if measured at time T1, but would be excluded from qualified pipeline 420 (i.e., included in unqualified pipeline 410) if measured at time T2.

### 2. Process Overview

Embodiments of processes for calculating, forecasting, and/or planning qualified pipeline, along one or more dimensions, based on the limited data that are typically available, will now be described in detail. It should be understood that the described processes may be embodied in one or more software modules that are executed by one or more hardware processors (e.g., processor 210), for example, as a software application (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the software application are executed by platform 110 and other portions or modules of the software application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processor(s) 210. In addition, the disclosed software may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

### 2.1. Qualified Pipeline Calculation

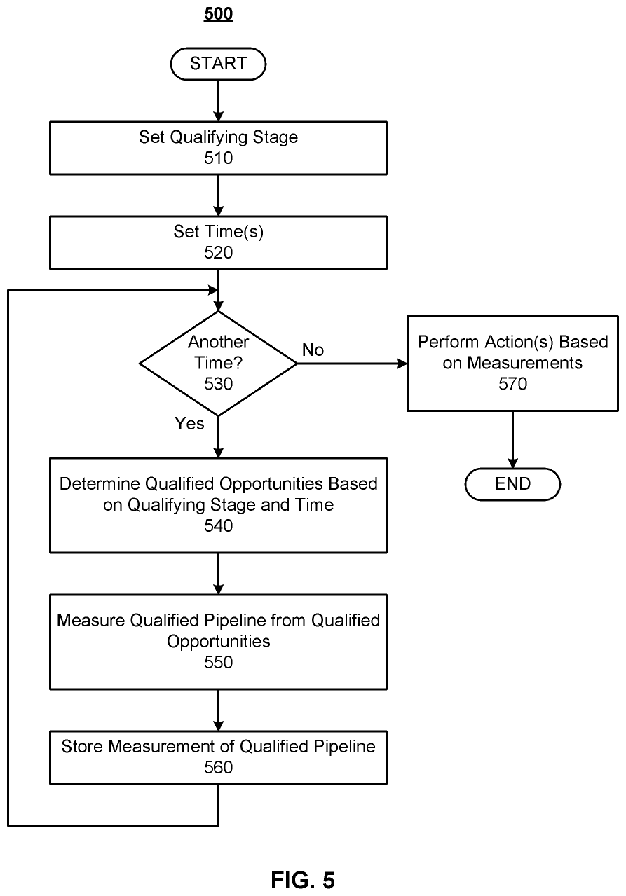

FIG. 5 illustrates a process 500 for calculating qualified pipeline 420, according to an embodiment. Process 500 may be executed by the application, comprising server application 112 and/or client application 132.

In subprocess 510, the qualifying stage is set. In an embodiment, the qualifying stage may be specified by a user. In this case, subprocess 510 may comprise generating a graphical user interface comprising an input configured to receive an indication of the user-specified qualifying stage. For example, the graphical user interface may comprise a drop-down menu that allows the user to select one stage from a list of all of the stages in pipeline 400. Alternatively, the qualifying stage may be a user setting, entity setting, or system setting. In this case, subprocess 510 may comprise retrieving the setting from memory. Regardless of the manner in which the qualifying stage is set, the qualifying stage (i.e., Stage Q) divides pipeline 400 into an unqualified pipeline 410 (e.g., Stage 1 to Stage Q−1) and a qualified pipeline 420 (e.g., Stage Q to Stage N).

In subprocess 520, one or more times are set. In an embodiment, the time(s) may be specified by a user. In this case, subprocess 520 may comprise generating a graphical user interface comprising an input configured to receive an indication of the user-specified time(s). For example, the graphical user interface may comprise one or more inputs that allow the user to select one or more times or time ranges. It should be understood that a time range can be defined by two times representing a start time and an end time. Alternatively, the time(s) may be a user setting, entity setting, or system setting. In this case, subprocess 520 may comprise retrieving the setting from memory.

In an embodiment, the qualifying stage and/or time(s) may be associated with a report. A user may select the report via the graphical user interface. In response, the application may retrieve the qualifying stage and time(s), associated with the selected report, from memory. In other words, subprocesses 510 and 520 may be performed in response to selection of a report by a user.

In an embodiment, the time(s) may be a plurality of times representing a time interval. The time interval may represent fiscal periods of the respective entity 320, which may be defined as a user, entity, or system setting, or by a fiscal report. For example, a fiscal year of entity 320 may be defined as a calendar period from February 1st to January 31st. In this case, subprocess 520 may set the times as the start and end of the fiscal year, the start or end of each fiscal year for a plurality of fiscal years, the start or end of each quarter, month, week, or day in one or more fiscal years, and/or the like. However, it should be understood that the time(s) set in subprocess 520 could comprise any arbitrary time, including a custom user-specified time (e.g., midnight on a particular day) or time interval (e.g., start or end of each day, week, month, quarter, year, etc., within a user-specified time range).

While not a necessity of any embodiment, in the described examples, it will generally be assumed that the time(s), set in subprocess 520, represent fiscal periods and can be set at one of a plurality of levels. For example, at a first and potentially highest level, the fiscal periods may be set as one or a plurality of fiscal years. At a second level, the fiscal periods may be set as one or a plurality of fiscal quarters in one or a plurality of fiscal years. At a third level, the fiscal periods may be set as one or a plurality of fiscal months in one or a plurality of fiscal quarters in one or a plurality of fiscal years. At a fourth level, the fiscal periods may be set as one or a plurality of fiscal weeks in one or a plurality of fiscal months in one or a plurality of fiscal quarters in one or a plurality of fiscal years. At a fifth and potentially lowest level, the fiscal periods may be set as one or a plurality of fiscal days in one or a plurality of fiscal weeks in one or a plurality of fiscal months in one or a plurality of fiscal quarters in one or a plurality of fiscal years. It should be understood that there may be even higher levels (e.g., five years) and/or lower levels of fiscal periods (e.g., hours), but that aggregation beyond a fiscal year and granularity beyond a fiscal week or day may not have much, if any, marginal benefit.

A user may utilize the graphical user interface to navigate between the various levels. For example, the user may navigate from viewing metrics for fiscal years to viewing metrics for the fiscal quarters in a particular fiscal year (i.e., viewing metrics at a higher level of granularity). In the reverse direction, the user may navigate from viewing metrics for fiscal quarters in a particular fiscal year to viewing metrics for fiscal years, including that particular fiscal year (i.e., viewing metrics at a higher level of aggregation). It should be understood that a user may navigate up and down, in this manner, through any of the various levels described herein.

In the event that the time(s) represent a single fiscal period, the time(s), set in subprocess 520, may consist of a single time representing the start or end of the fiscal period (e.g., 12:00 am on the first day of the fiscal period or 11:59 pm on the last day of the fiscal period) or consist of both a start time and end time of the fiscal period (e.g., 12:00 am on the first day and 11:59 pm on the last day of the fiscal period). In the event that the time(s) represent a plurality of fiscal periods, the times may comprise a time at the start of each fiscal period (e.g., 12:00 am on the first day of each fiscal period) or at the end of each fiscal period (e.g., 11:59 pm on the last day of each fiscal period). In other words, in this case, the times, set in subprocess 520, would be a plurality of times separated by a fixed time interval.

In subprocess 530, it is determined whether or not qualified pipeline 420 needs to be measured for another time. Subprocess 530 is the root of a loop formed by subprocesses 540-560, which may be executed for each time at which qualified pipeline 420 is to be measured, as set in subprocess 520. Thus, the loop formed by subprocesses 540-560 may be performed with only a single iteration if qualified pipeline 420 is to be measured for only a single time, or may be performed over a plurality of iterations if qualified pipeline 420 is to be measured for a plurality of times (e.g., representing a time range or time interval). If another time remains to be considered (i.e., “Yes” in subprocess 530), an iteration of subprocesses 540-560 is executed for that time. Otherwise, if no more times remain to be considered (i.e., “No” in subprocess 530), process 500 proceeds to subprocess 570.

In subprocess 540, the set of qualified opportunities is determined based on the qualifying stage, set in subprocess 510, and the time under consideration from the time(s) set in subprocess 520. In particular, subprocess 540 may identify all opportunities 310 that have reached the qualifying stage at the time under consideration. An opportunity 310 reaches the qualifying stage at a time if the opportunity 310 is within qualified pipeline 420 (e.g., one of Stages Q through N) at the time.

While all of these identified opportunities 310 may be included in the set of qualified opportunities, in an embodiment, any of the identified opportunities 310 that have subsequently become unqualified are excluded from the set of qualified opportunities. For example, if the time under consideration is a historical time, an opportunity 310 that is within qualified pipeline 420 at that historical time could initially be identified as a qualified opportunity. However, if, at a subsequent time, the opportunity 310 transitioned back to unqualified pipeline 410 (e.g., any of Stages 1 to Q−1) and currently remains in unqualified pipeline 410, that opportunity 310 may be excluded from the set of qualified opportunities, even though it had technically qualified at the time under consideration. In an alternative embodiment, opportunities 310 may be included in the set of qualified opportunities, as long as they are within qualified pipeline 420 at the time under consideration, even if they are currently in unqualified pipeline 410. In yet another embodiment, this may be a user or entity setting. In other words, the user or an organization can specify (e.g., via a toggle input of the graphical user interface) whether or not opportunities 310, which were in qualified pipeline 420 at the time under consideration but are currently in unqualified pipeline 410, should be included in the set of qualified opportunities in subprocess 540.

In an embodiment, subprocess 540 may retrieve or otherwise receive opportunities 310 from a CRM system 140. In an embodiment, server application 112 queries CRM system 140 for all opportunities 310 (e.g., represented as data objects in a relational database of CRM system 140) that satisfy one or more criteria, for example, via an API of CRM system 140. For example, the query may request all opportunities 310 that have reached the qualifying stage (e.g., are associated with at least one of Stages Q through N, and optionally remain in qualified pipeline 420) for a particular entity 320, product 330, and/or account 340. In an alternative embodiment, server application 112 may query CRM system 140 for, or otherwise receive, all opportunities 310 or all opportunities 310 satisfying one or more criteria (e.g., associated with a particular entity 320, product 330, and/or account 340), and then extract those opportunities 310 that satisfy one or more additional criteria (e.g., have reached the qualifying stage, and optionally currently remain in qualified portion 420).

CRM system 140 may retain a record of each stage in which an opportunity 310 has been, along with the time at which the opportunity 310 was in each stage. The application may recreate the progression of each opportunity 310, through the stages of pipeline 400 over time, based on the stages and times recorded by CRM system 140. In other words, the application may generate a time series of stages, which represents the chronological journey that an opportunity 310 has taken through pipeline 400. As a result, the application can identify what stage an opportunity 310 was in at any given point in time, by determining what stage is the most recent stage in the time series that chronologically precedes that given point in time. The application can also easily identify in which stage an opportunity is currently, by simply determining the most recent stage in the time series. In addition, the application may maintain the logical sequence of stages in pipeline 400, such that stages in qualified pipeline 420 can be easily distinguished from stages in unqualified pipeline 410. This enables subprocess 540 to quickly determine whether or not an opportunity 310 should be included in the set of qualified opportunities at any given time.

In some cases, the stages in pipeline 400 may change over time. For example, as an entity 320 or CRM system 140 evolves over time, new stages may be added to pipeline 400, stages may be removed from pipeline 400 (e.g., as they become deprecated), stages may be changed (e.g., converted from active to inactive or inactive to active), stages may be reordered in pipeline 400, and/or the like. In this case, the application may maintain a mapping (e.g., stored in database(s) 114) between the current stages and the historical stages. If a historical stage has changed, the historical stage may be mapped to the corresponding current stage, and it may be determined that the historical stage is in qualified pipeline 420 when the corresponding current stage is in qualified pipeline 420, and that the historical stage is in unqualified pipeline 410 when the corresponding current stage is in unqualified pipeline 410. If a historical stage has been removed, such that there is no corresponding current stage, the historical stage may be mapped to a position (e.g., before Stage Q, after Stage Q, etc.) in the current pipeline 400, such that it can be easily determined whether the historical stage would have been in unqualified pipeline 410 or qualified pipeline 420 given a current qualifying stage. Thus, qualified pipeline 420 can be calculated for a past time, based on any set qualifying stage, even if the stages have changed since the past time period.

Regardless of the manner in which opportunities 310 are acquired and the criteria by which they are included, the output of subprocess 540 is a set of opportunities 310 that are to be included in qualified pipeline 420 for the time under consideration. Each opportunity 310 may be represented in the set by a data object comprising one or more attributes of the opportunity 310. One of these attribute(s) may be a monetary value of the opportunity 310. The set of opportunities 310 may be stored in a relational database (e.g., in database(s) 114) for querying.

In subprocess 550, qualified pipeline 420 is measured based on the set of qualified opportunities, determined in subprocess 540. Qualified pipeline 420 may be measured as the sum of monetary values of all qualified opportunities, the average monetary value of all qualified opportunities, the number or count of all qualified opportunities, and/or the like. The monetary value or other metric may be derived from the attributes of the qualified opportunities. The particular metric to be used (e.g., the attribute to be used and the mathematical operation to be performed) may be a user-specified input or user, entity, or system setting. Regardless of the particular metric that is used, the measured value of qualified pipeline 420 is a point-in-time value, representing the value of qualified pipeline 420 at the point in time under consideration. It should be understood that the measure (e.g., monetary value) of a particular opportunity 310 may change over time. For example, the measure of an opportunity 310 at the time under consideration may be different than the measure of that opportunity 310 when it was first created in CRM system 140 and/or at the current time.

In an embodiment in which the set of qualified opportunities is stored in one or more tables in a relational database, the metric of qualified pipeline 420 may be calculated by executing a single query, such as a single Structured Query Language (SQL) query. The single query may sum a particular attribute (e.g., monetary value) and/or number of all opportunities 310 for one or more dimensions (e.g., one or more GTM segments 350, one or more products 330, and one or more accounts 340), while also selecting the most recent stage of those opportunities 310 and excluding opportunities 310 whose most recent stage is in unqualified pipeline 410 or represents a lost opportunity (e.g., is in a closed-lost stage). The single query may group the sum by one or more dimensions, such as products 330, accounts 340, GTM segments 350, products 330, fiscal periods, opportunity sources, channels, or other classifications, and/or the like. To facilitate the query, the relational database may organize each qualified opportunity in the set of qualified opportunities as a time series of stages, as discussed elsewhere herein.

In subprocess 560, the metric of qualified pipeline 420, measured in subprocess 550, is stored. The measured values of qualified pipeline 420 may be stored by as-of dates, such as of the current time, as of the end of a fiscal week, as of the end of a fiscal month, as of the end of a fiscal quarter, as of the end of a fiscal year, as of the end of a custom time range or time interval, and/or the like. This enables a user to view qualified pipeline 420 for a specific qualifying stage and specific time period from a historical and current time perspective. In particular, a user may easily see the answer to the question of “how much pipeline was qualified in a specific time period?” Qualified pipeline 420 may be tracked over any time range or interval (e.g., daily, weekly, monthly, quarterly, yearly, etc.), so that a user can visualize how qualified pipeline 420 has changed over time over one or more dimensions.

The metric of qualified pipeline 420 may be organized (e.g., segregated) by any number of dimensions, including, for example, at least GTM segment 350 and product 330. In other words, a metric of qualified pipeline 420 of opportunities 310 is calculated, stored, and potentially displayed in a graphical user interface for at least each GTM segment 350 and product 330 across all accounts 340 for an entity 320.

Additionally or alternatively, the dimension(s) by which the metric of qualified pipeline 420 are organized may include, for example, the sources of the qualified opportunities 310. A source of a qualified opportunity 310 represents the source from which the original opportunity 310 originated (e.g., within the respective CRM system 140). General examples of sources include, without limitation, marketing, sales, partners, resellers, and/or the like. Specific examples of sources include Google™ search, Bing™ search, Yahoo!™ search, Drift™, an entity's website, advertising (e.g., on Google™ or LinkedIn™), webinars, tradeshows, direct mail, third-party vendors, and/or the like. At least some sources may be user-defined sources. An entity 320 can manage the sources by associating opportunities 310 with particular sources manually and/or automatically based on one or more rules. The source of an opportunity 310 may be defined as an attribute of that opportunity 310 (e.g., a source identifier in a field of the data object representing the opportunity 310).

Additionally or alternatively, the dimensions by which the metric of qualified pipeline 420 are organized may include, for example, the channel and campaign of the qualified opportunities 310. A pairing of channel and campaign for a given opportunity 310 may be referred to herein as “category” of the opportunity 310. The campaign that produces an opportunity 310 may be defined as an attribute of that opportunity 310 (e.g., a campaign identifier in a field of the data object representing the opportunity 310). Channels may be user-defined. In particular, a user may associate one or more sources with a single channel. In an embodiment, a source can only belong to one channel, but a channel may be associated with one or a plurality of sources. Essentially, channels are a sub-classification of sources. Any sources that are not associated with a particular channel may be automatically associated with an “other” channel that can be used as a catch-all. The table below illustrates an example set of channels and their associated source(s):

| Channel | Source(s) |
|---|---|
| Search | Google ™ Natural Search, Bing ™ |
| | Natural Search, Yahoo! ™ Search |
| Website | Drift ™, website |
| Advertising | Google ™, LinkedIn ™ |
| Events | webinars, tradeshows |
| Direct Mail | direct mail |
| Third-Party Lists | Slintel ™, etc. |
| Other | any source not associated with a channel |

In subprocess 570, one or more actions may be performed based on the metrics of qualified pipeline 420 stored in one or more iterations of subprocess 560. For example, the performance of qualified pipeline 420 (i.e., from an open opportunity 310 to a closed and won opportunity 310) may be tracked for one or more of the dimensions described elsewhere herein (e.g., GTM segment 350, product 330, source, channel, campaign, etc.). Pipeline performance may be specific to a time period (e.g., fiscal period) and tracked by total monetary value, average monetary value, number of opportunities 310, and/or the like. The pipeline performance may be tracked by one or more metrics to a closed stage (e.g., representing a won or lost opportunity 310).

In an embodiment, the opportunity win rate is tracked as one performance metric of pipeline 400. The opportunity win rate is the ratio (e.g., as a percentage) of the number of opportunities 310 that were closed (e.g., associated with a stage that represents that an opportunity 310 is no longer active, due to being either won or lost) and won (e.g., associated with a stage representing a sale) in a specific time period to the total number of opportunities 310 that were closed in the specific time period:

$$Opportunity Win Rate = \frac{No . of Opportunities Won}{No . of Opportunities Won + No . of Opportunities Lost}$$

In an embodiment, the pipeline win rate is tracked as one performance metric of pipeline 400. The pipeline win rate is the ratio (e.g., as a percentage) of the value (e.g., sum of monetary values) of opportunities 310 that were closed and won in a specific time period to the total value of opportunities 310 that were closed in the specific time period:

$$Pipeline Win Rate = \frac{Value of Opportunities Won}{Value of Opportunities Won + Value of Opportunities Lost}$$

In an embodiment, the average sales cycle is tracked as one performance metric of pipeline 400. The average sales cycle is the average amount of time (e.g., number of days) between opportunities 310 first entering qualified pipeline 420 and being closed and won. In other words, the average sales cycle indicates how long it takes on average to convert qualified pipeline 420. The sales cycle may be tracked by time cohorts, such as 30, 60, and 90 days, or 60, 120, and 180 days. These time cohorts may be configurable.

The opportunity win rate, pipeline win rate, and/or average sales cycle may be used as an input to pipeline planning, which may be another action performed in subprocess 570. In particular, a user may create an accurate pipeline plan based on the metric of actual pipeline performance. Advantageously, the metric of actual pipeline performance enables the user to account for critical conversion and time-centric parameters, as opposed to simply guessing the amount and timing of pipeline that needs to be generated. The pipeline plan may based on a monetary value (e.g., total and/or average monetary value) of opportunities 310, number of opportunities, and/or the like.

In addition, the pipeline performance may be tracked against a past pipeline plan. For example, the difference or delta between a metric of actual pipeline performance and the pipeline plan may be calculated. This difference may be calculated over one or more time periods (e.g., daily, weekly, monthly, quarterly, yearly, etc.). Thus, a user may easily visualize deviations (e.g., underperformance or overperformance) of the pipeline performance from the pipeline plan.

In an embodiment, the application may determine the top buyer personas associated with won opportunities 310 in one or more dimensions. For example, buyer personas that are associated with won opportunities 310 for each account 340, product 330, and/or GTM segment 350 may be ordered according to a metric, such as frequency (e.g., in descending order from most frequent to least frequent). In terms of frequency, for each won opportunity 310 (e.g., an opportunity in a closed-won stage), the buyer persona(s) associated with the won opportunity 310 may be determined. Then, the number of times that each buyer persona was associated with won opportunities 310 can be counted. Then, the buyer personas may be ordered from the highest count (i.e., most frequent) to the lowest count (i.e., least frequent).

It should be understood that a buyer persona represents an individual associated with an account 340. This individual may be a known or unknown contact at the account 340, such as an employee or other agent of a business (i.e., represented by an account 340) to which entity 320 is selling a product 330. However, in an embodiment, buyer personas may be abstracted to consist of or comprise a job level and job function, as opposed to specific individuals. In this case, the list of ordered buyer personas may be a list of job levels and job functions that are associated with won opportunities 310.

The ordered list of buyer personas or a predefined number of top buyer personas (i.e., having the highest counts) in the ordered list may be provided to a user, for example, in a graphical user interface of the application. Knowing which buyer personas are most frequently associated with won opportunities 310 can be used to improve marketing and pipeline performance. For example, a buyer persona at the top of the list may be engaged earlier in the sales process to increase the likelihood of winning an opportunity 310 and/or reducing the sales cycle for the opportunity 310. The buyer persona may be engaged via targeted advertising (e.g., using content personalization). In the event that the buyer persona is represented as a job level and job function, engagement of the buyer persona may comprise identifying a current employee of account 340 that has that job level and job function (e.g., via CRM system 140, web crawling, proprietary database, third-party data sources, etc.), and then engaging that current employee with a targeted advertising campaign. In general, the ordered list of buyer personas creates additional meaning on top of the pipeline data, by providing indications of what job levels and job functions are most relevant to closing a deal.

In an embodiment, the application measures the open qualified pipeline. The open qualified pipeline is a measure of opportunities 310 in qualified pipeline 420 that have not reached a closed stage. In other words, the open qualified pipeline is a measure of opportunities 310 that have reached the qualifying stage but not a closed stage. It should be understood that a closed stage is any stage that indicates that an opportunity 310 is inactive and has been either won or lost. The measure of open qualified pipeline may comprise the total monetary value, average monetary value, and/or number of opportunities 310. Each opportunity 310 may be associated with an expected closing date. In this case, the open qualified pipeline may be tracked by qualification date and expected closing date.

### 2.2. Forecasting

In an embodiment, one of the action(s) performed in subprocess 570 may be forecasting the future value of qualified pipeline 420 based on the current value of qualified pipeline 420. The forecasting may be performed by a forecasting function of the disclosed application. Forecasting may help the chief marketing officer (CMO), marketing leader, or other user on behalf of entity 320 to streamline marketing efforts, for example, by forecasting the metric of qualified pipeline 420 at the end of a fiscal period (e.g., end of the quarter or month). Notably, the forecasted value of qualified pipeline 420 will continually change based on the current value of qualified pipeline 420. The user can track these changes in the forecasted value of qualified pipeline 420 to determine if qualified pipeline 420 will hit a target, representing a pipeline plan. If the user determines that qualified pipeline 420 will fall short of the target, the user may take remedial action, such as increasing efforts (e.g., time and/or money) with an existing marketing campaign, launching a new marketing campaign, engaging with additional buyer personas (e.g., from the ordered list of buyer personas described elsewhere herein), and/or the like, to improve the likelihood of reaching the target.

A forecast of qualified pipeline 420 calculates the metric of qualified pipeline 420 that is likely to be at a future point in time. The metric of qualified pipeline 420 may be forecast in one or more dimensions. These dimensions may include, for example, fiscal time period (e.g., fiscal week, month, quarter, year, etc.), GTM segment 350, product 330, source, channel, campaign, and/or the like. A user may specify the dimension(s) in which the metric of qualified pipeline 420 is forecast. The forecasted metric of qualified pipeline 420 may comprise a forecasted total monetary value, a forecasted average monetary value, a forecasted number of opportunities 310, and/or the like. The application may also track changes or deltas in the forecasted metric of qualified pipeline 420 over time.

It should be understood that the metric of qualified pipeline 420 that is forecast may be the same as the metric of qualified pipeline 420 that is calculated in subprocess 550. For example, the forecast metric may comprise a sum of monetary value, average monetary value, and/or number of opportunities 310 in qualified pipeline 420 at some future point in time. This metric may be calculated in the same manner as in subprocess 550, using one or more attributes of each opportunity 310 that is forecast to be in qualified pipeline 420 at the future point in time. A user may specify which attributes of opportunities 310 are to be used to calculate the forecast metric.

In an embodiment, two forecasts are generated: (i) a base-case forecast; and (ii) a best-case forecast. The base-case forecast is the minimum value of the metric of qualified pipeline 420 that is likely to be generated, whereas the best-cast forecast is the maximum value of the metric of qualified pipeline 420 that is likely to be generated. If historical data are available, the forecasting function of the application may return both the base-case forecast and the best-case forecast. If only partial historical data are available, the forecasting function may return only the base-case forecast. If no historical data or insufficient historical data are available, the forecasting function may return no forecast.

For a given future time (e.g., representing the end of a fiscal period), the forecast metric of qualified pipeline 420 may be calculated as:

F=G×N+B

wherein F is the forecasted value of the metric of qualified pipeline 420 at the future time, G is the growth rate of the value of qualified pipeline 420 for a predefined time interval (e.g., day, week, etc.), N is the number of predefined time intervals remaining until the future time (e.g., until the end of a fiscal period), and B is the current value of qualified pipeline 420 (i.e., at the current time).

In the event that the future time represents the end of a fiscal period, it should be understood that the fiscal period may be a week, month, quarter, year, or the like. In this case, B may represent the current value of qualified pipeline 420 since the start of the fiscal period, such that F represents the forecasted value of the metric of qualified pipeline 420 that will be generated over the entire fiscal period. In other words, for a fiscal period that spans from a past start time to a future end time, the current value of the metric of qualified pipeline 420 may be calculated (e.g., using process 500) for the portion of the fiscal period that spans from the past start time to the current time, and then, the forecasted value F of the metric of qualified pipeline 420 at the end of the fiscal period may be calculated using the current value of the metric of qualified pipeline 420 as B.

The predefined time interval may be set to any suitable interval, such as a day, a week, or the like. For example, if the fiscal period is a month, the predefined time interval may be set to a day (i.e., a 24-hour period), such that the growth rate G represents the expected increase in the value of the metric of qualified pipeline 420 over one day. For a 30-day month, there will be thirty predefined time intervals. For a forecast calculated after the first day of the month, N=29; for a forecast calculated after the second day of the month, N=28; for a forecast calculated after the third day of the month, N=27; and so on and so forth until after the thirtieth day of the month, N=0 (i.e., there is no forecast for the current fiscal period, although a forecast may be calculated for the next fiscal period).

The growth rate G may be computed based on one or more of the following forecasting models: (i) seasonal average; (ii) moving average; and/or (iii) linear drift. It should be understood that these are three examples, and that the forecasting model(s) used may include fewer, more or different forecasting models than those described herein. The growth rate G may be calculated using any one of these or other forecasting models. Different accounts 340 may be associated with different forecasting models and/or different time periods to be forecast may be associated with different forecasting models, in order to maximize forecasting efficiency. For example, a first account 340 may be associated with a different forecasting model than a second account 340, and/or a first time period may be associated with a different forecasting model than a second time period.

In an embodiment, the growth rate G is calculated using each of a plurality of independent forecasting models. These independent forecasting models may comprise seasonal average, moving average, linear drift, and/or any other suitable model. Each independent forecasting model may be executed to output a value for the growth rate G, and the application may determine a single value for the growth rate G from the values output by the plurality of independent forecasting models. For example, the application may select the minimum and/or maximum output value as the growth rate G, an average or weighted average of the output values as the growth rate G, and/or the like. In an embodiment, the application uses the minimum output value as the growth rate G to calculate the base case of forecasted value F of the metric of qualified pipeline 420, and also uses the maximum output value as the growth rate G to calculate the best case of forecasted value F of the metric of qualified pipeline 420.

In a forecasting model that utilizes the seasonal average, the growth rate G for a future time period is calculated as:

$$G = \frac{{\sum }_{i = 1}^{n} {K}_{i}}{n}$$

wherein Kᵢ is the actual growth rate over the same time period during a prior fiscal year i, and n is the number of previous fiscal years to be used in the computation (n≥1). The value of K for the same time period in a preceding fiscal year may be computed as:

$$K = \frac{\begin{matrix}Qual . Pipeline at End of Time Period - \\ Qual . Pipeline at Start of Time Period\end{matrix}}{No . of Intervals in Time Period}$$

In other words, the growth rate G for a time period is calculated as the average actual growth rate for the same time period in n prior fiscal years. In order to utilize the seasonal average as a forecasting model, all that is required is historical data for at least one corresponding time period in at least one prior fiscal year.

In a forecasting model that utilizes the moving average, the growth rate G for a future time period is calculated as:

$$G = \frac{{\sum }_{i = 1}^{n} {K}_{i}}{n}$$

wherein Kᵢ is the actual growth rate over the same time period during a prior fiscal period i, and n is the number of prior fiscal periods to be used in the computation. The value of K for the same time period in a preceding fiscal period may be computed as:

$$K = \frac{\begin{matrix}Qual . Pipeline at End of Time Period - \\ Qual . Pipeline at Start of Time Period\end{matrix}}{No . of Intervals in Time Period}$$

In other words, the growth rate G for a time period is calculated as the average actual growth rate for the same time period in n prior fiscal periods. In order to utilize the moving average as a forecasting model, all that is required is historical data for at least one corresponding time period in at least one prior fiscal period.

In a forecasting model that utilizes linear drift, the growth rate G for a future time period is calculated as:

$$G = \frac{\begin{matrix}Qual . Pipeline at End of Time Period - \\ Qual . Pipeline at Start of Time Period\end{matrix}}{No . of Intervals in Time Period}$$

wherein any preceding time period may be used as the Time Period. Thus, in order to utilize linear drift as the forecasting model, all that is required is historical data for at least one time period in the past.

In an embodiment, qualified pipeline 420 may be forecast by channel. The growth rate G_{c} for a given channel c may be computed in the same manner as above, but using the historical measure of qualified pipeline 420 for the given channel. G, may be used as a distribution factor to bound the channel-specific forecast, based on the overall forecast, with a minimum value and a maximum value:

$${F}_{c \_ min} = \frac{min {G}_{c} + max {G}_{c}}{{\sum }_{i = 0}^{C} min {G}_{i} + {\sum }_{i = 0}^{C} max {G}_{i}} \times min ( G \times N ) + {B}_{c} \\ {F}_{c \_ max} = \frac{min {G}_{c} + max {G}_{c}}{{\sum }_{i = 0}^{C} min {G}_{i} + {\sum }_{i = 0}^{C} max {G}_{i}} \times max ( G \times N ) + {B}_{c}$$

wherein min is a function that finds a minimum value, max is a function that finds a maximum value, F_{c_min} is the minimum forecast value for qualified pipeline 420 for channel c at the end of the future time period, F_{c_max} is the maximum forecast value for qualified pipeline 420 for channel c at the end of the future time period, B_{c} is the current value of qualified pipeline 420 (i.e., at the current time) for channel c, G_{c} is the growth rate of the channel-specific qualified pipeline, G is the growth rate of the value of the overall qualified pipeline over a predefined time interval, N is the number of predefined time intervals remaining until the end of the future time period, min(G×N) is the minimum value of G×N across all forecasting models, max(G×N) is the maximum value of G×N across all forecasting models, and C is the total number of channels in qualified pipeline 420. It should be understood that F_{c_min} may be used as the base-case forecast, and F_{c_max} may be used as the best-case forecast.

### 2.3. Pipeline Planning

As mentioned above, the measure of qualified pipeline may be used for pipeline planning. For example, pipeline planning may be an action performed in subprocess 570 of process 500. As will be described herein, pipeline plans may be calculated from booking targets using a reverse waterfall technique.

A booking refers to a customer commitment to purchase a product. This customer commitment may comprise some form of contract between entity 320 and account 340, representing a B2B transaction. Each booking may be associated with a monetary value. An opportunity 310 becomes a booking when the opportunity 310 enters a stage representing that an opportunity 310 is closed and won, which may be referred to herein as the “closed-won” stage.

A pipeline plan refers to a value of the metric of qualified pipeline 420 (e.g., total monetary value) that an entity 320 must produce by a specific time to be on pace to satisfy a future booking target (e.g., a financial goal expected by its executives or shareholders). The booking target may comprise a desired value, at a particular future date, of opportunities 310 in qualified pipeline 420 that are booked (i.e., in the closed-won stage). The pipeline plan usually comprises a monetary value of qualified pipeline 420 at the end of a specific time period, but could also comprise a number of opportunities 310 in qualified pipeline 420 at the end of the specific time period, and/or any other relevant metric.

A pipeline plan may be calculated in one or more dimensions, in addition to time. For example, in an embodiment, a pipeline plan is calculated for each product 330 and GTM segment 350. However, it should be understood that pipeline plans may be calculated along any dimension or combination of dimensions.

In an embodiment, a reverse waterfall technique is used to determine the pipeline plan at a specific time that is required to be on pace to satisfy a booking target. In other words, the reverse waterfall technique determines, given a specified time (e.g., in the past, present, or future) and a booking target to be achieved at a future time, how much qualified pipeline needs to be generated by the specified time to achieve the given booking target at the future time.

Many opportunities 310 may never enter the closed-won stage. These opportunities 310 may instead enter a stage representing that an opportunity 310 is closed and lost, which may be referred to herein as the “closed-lost” stage. The closed-lost stage may be within unqualified pipeline 410. Alternatively, these opportunities 310 may remain open or may be deferred. Consequently, in order to predict the achievement of booking targets, the application may calculate win rate, sales cycle, and/or average won opportunity size (e.g., if the pipeline performance is computed based on number of qualified opportunities 310) for the dimensions (e.g., product 330 and GTM segment 350) in which the pipeline plan is to be calculated. The win rate is the ratio (e.g., as a percentage) of opportunities 310 that were closed and won in a specific time period to all opportunities 310 closed in the specific time period. The sales cycle is the average amount of time (e.g., as a number of days) between opportunities 310 first entering qualified portion 420 of pipeline 400 and being closed and won. The average won opportunity size is the average size (e.g., as an average monetary value) of opportunities 310 that were closed and won in a specific time period.

The challenge of pipeline planning is to calculate the metric of qualified pipeline 420 that must be generated at time T1 to satisfy the booking target at time T2, wherein T2 is subsequent in time to T1. For example, given a booking target of X at the end of the fiscal year, the application may, before or at the start of the fiscal year, calculate the metric of qualified pipeline 420 that is required at the end of each of the first quarter (Q1), second quarter (Q2), and third quarter (Q3) of that fiscal year, to be on pace to achieve a metric of qualified pipeline 420 with a value of X at the end of the fourth quarter (Q4) of the fiscal year, and therefore, by the end of the fiscal year itself. Alternatively or additionally, the application may calculate the metric of qualified pipeline 420 that must be generated in each of the first quarter (Q1), second quarter (Q2), third quarter (Q3), and fourth quarter (Q4) (i.e., the increase in the metric of qualified pipeline 420 in each quarter) to reach the booking target of X by the end of the fiscal year. In either case, the pipeline plan may adjust over time. For example, at the end of the first quarter, the application may recalculate the metric of qualified pipeline 420 required in each of the second, third, and/or fourth quarters based on the actual value of the metric of qualified pipeline 420 achieved in the first quarter. Similarly, in the middle of a quarter or other fiscal period, the application may calculate the metric of qualified pipeline 420 required in the remaining portion of the fiscal period.

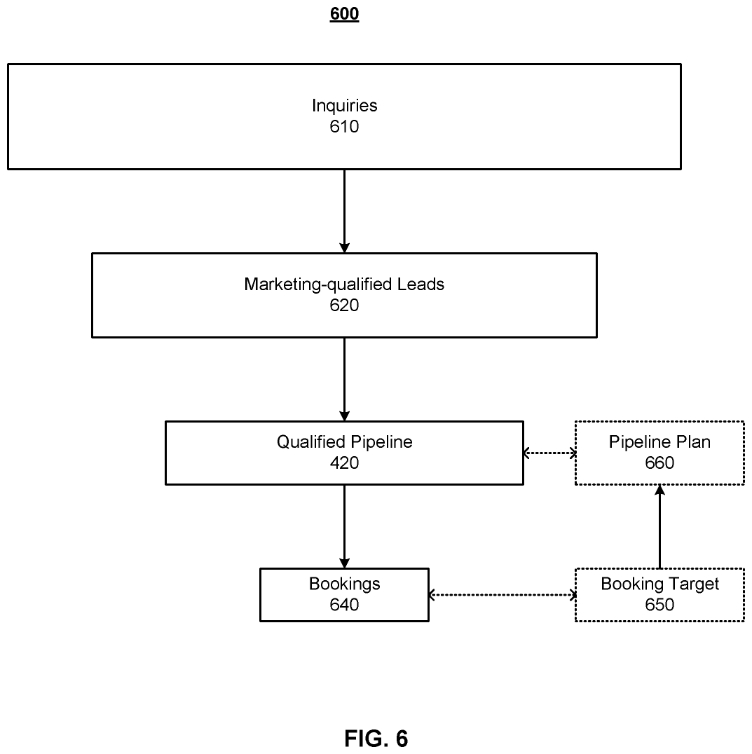

FIG. 6 illustrates an example of a sales funnel 600, according to an embodiment. At the top of sales funnel 600, are all inquiries 610. Inquiries 610 are narrowed down into marketing-qualified leads 620. Marketing-qualified leads 620 are potential customers that have been reviewed by the marketing team and satisfy one or more criteria which indicate that the potential customers should be passed on to the sales team. Marketing-qualified leads 620 may enter pipeline 400 as opportunities 310, where they are narrowed down into qualified pipeline 420. A portion of opportunities 310 in qualified pipeline 420 gets converted into bookings 640.

An entity 320 may determine a booking target 650 for some future time. Booking target 650 may be determined based on past bookings 640, business needs, and/or the like. In the reverse waterfall technique, a pipeline plan 660 for one or more specific times, preceding the future time but also potentially in the future, may be determined from booking target 650. Pipeline plan 660 represents the value of the metric of qualified pipeline 420 that must be achieved by a specific time in order to be on pace to satisfy booking target 650 at the future time. Pipeline plan 660 may be derived from booking target 650 using metrics, such as win rate, sales cycle, and/or average won opportunity size. Pipeline plans 660 may be derived for each source, using a source allocation, so that the marketing team can understand how much qualified pipeline 420 needs to be generated from each source. While pipeline plan 660 may account for open, won, and lost opportunities 310, the application may provide flexibility for users to generate a pipeline plan 660 that accounts for only open and won opportunities 310 (i.e., exclude lost opportunities 310).

The application may comprise a pipeline-planning function that accepts, as input, a booking model, an assumption model, and/or an allocation model. The booking model may comprise or compute a booking target at the end a specific time period (e.g., fiscal month, quarter, year, etc.). The assumption model may comprise or compute planning assumptions, such as the win rate, sales cycle, and/or average won opportunity size for a specific time period. The allocation model may comprise or compute the proportion of qualified pipeline 420 that is to be allocated to each of a plurality of sources. In an embodiment, a booking model, assumption model, and/or allocation model may be provided for each of one or more dimensions, such as GTM segment 350 and source. For example, the pipeline-planning function may output a pipeline plan for each GTM segment 350 and source for a specific time period. These pipeline plans for combinations of dimensions, such as GTM segments 350, sources, and time periods, may be collectively referred to herein as the “pipeline model.”

Pipeline planning is generally an iterative and collaborative process. Typically, a planning team analyzes different scenarios to create the optimal pipeline plans. If business conditions change, the planning team may need to analyze additional scenarios. Thus, in an embodiment, the pipeline-planning function of the application may be configured to accept a plurality of booking models, assumption models, and/or allocation models as input. This enables a more flexible planning process.

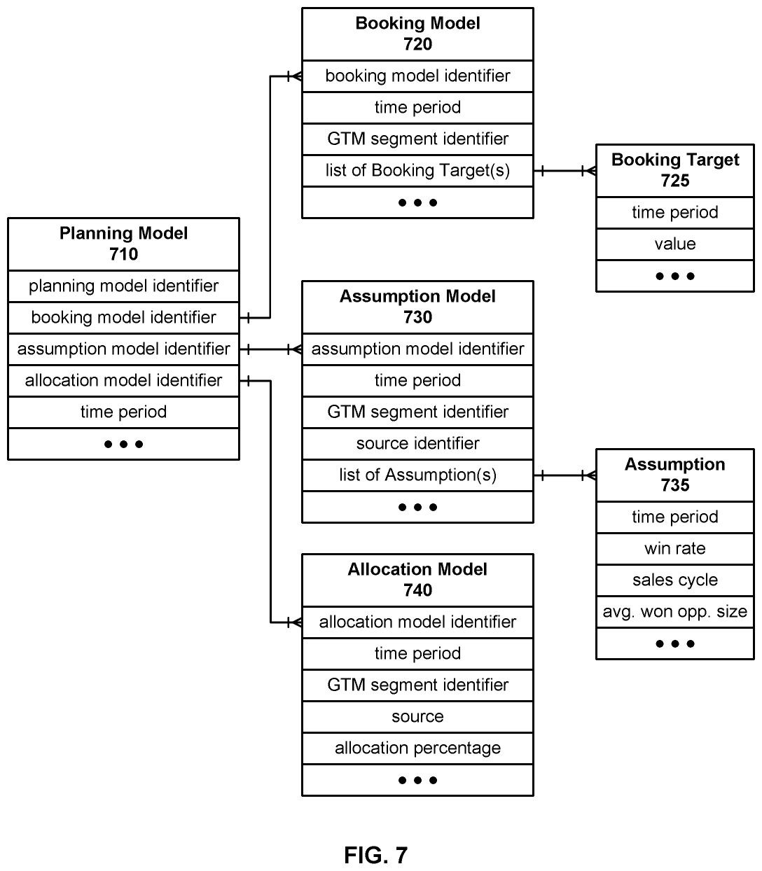

FIG. 7 illustrates an example high-level entity relationship diagram for the various data structures used by the pipeline-planning function, according to an embodiment. One or more planning models 710 may be generated for a pipeline 400. Each planning model 710 may comprise a planning model identifier, a booking model identifier, an assumption model identifier, an allocation model identifier, and a time period encompassed by planning model 710. It should be understood that planning model 710 may comprise additional information, such as a name, description, and/or the like, and that the various components may be represented using any suitable data type or structure.

Each booking model identifier may be associated with one or a plurality of booking models 720 that define a booking target. Each booking model 720 may comprise the booking model identifier, a time period encompassed by booking model 720, a GTM segment identifier (i.e., identifying a GTM segment 350), and a list of one or a plurality of booking targets. Each booking target 725 in the list of booking target(s) may comprise a time period and a value for that time period (e.g., monetary value of the booking target for that time period). The value may be automatically computed or manually input. It should be understood that booking model 720 and/or booking target 725 may comprise additional information, and that the various components may be represented using any suitable data type or structure.

Each assumption model identifier may be associated with one or a plurality of assumption models 730 that define one or more parameters representing assumptions. Each assumption model 730 may comprise the assumption model identifier, a time period encompassed by assumption model 730, a GTM segment identifier, a source identifier (i.e., identifying a source), and a list of one or a plurality of assumptions. Each assumption 735 in the list of assumption(s) may comprise a time period and values of one or more parameters (e.g., win rate, sales cycle, and/or average won opportunity size) for that time period. The values may be automatically computed or manually input. In an embodiment, the values of the parameters may be derived from the metric of qualified pipeline 420 calculated by process 500 for one or more times. It should be understood that assumption model 730 and/or assumption 735 may comprise additional information, and that the various components may be represented using any suitable data type or structure.

Each allocation model identifier may be associated with one or a plurality of allocation models 740 that define a proportion of the metric of qualified pipeline 420 that is allocated to each of one or more sources. Each allocation model 740 may comprise the allocation model identifier, a time period encompassed by allocation model 740, a GTM segment identifier, a source identifier, and an allocation percentage for the identified GTM segment 350 and source. It should be understood that allocation model 740 may comprise additional information, and that the various components may be represented using any suitable data type or structure.

As an example, the pipeline plan for a specific source may be computed as:

$${P}_{tp} = \frac{{A}_{tp} \times {R}_{t}}{W}$$

wherein Pₜₚ is the amount of qualified pipeline needed from the specific source for time interval p in fiscal period p, Aₜₚ is the amount of bookings allocated to the specific source for time interval t in fiscal period p, W is the win rate for the specific source as a ratio of the amount of opportunities 310 that were closed and won over the total amount of opportunities 310 that were closed, and Rₜ is a tracking ratio of the amount to be tracked over the total amount of qualified pipeline (e.g., to exclude the amount of qualified pipeline that was lost in time interval t).

The amount of bookings Aₜₚ may be computed as:

$${A}_{tp} = {\sum }_{i , j}^{t , p} ( {FB}_{ij} \times {PR}_{ij} \times {PCT}_{ij} )$$

wherein FBᵢⱼ is the total amount of bookings for time interval i in fiscal period j, PRᵢⱼ is the proportional ratio that determines what ratio of FBᵢⱼ is used for time interval i in fiscal period j, and PCTᵢⱼ is the percentage of the total amount of bookings that is allocated to the specific source. PRᵢⱼ may be computed based on the sales cycle SC as follows:

$$\begin{matrix}\begin{matrix}if {SD}_{ij} < {SD}_{tp} + \\ SC \& {ED}_{ij} < {ED}_{tp} + SC ,\end{matrix} & then {PR}_{ij} = \frac{{ED}_{ij} - ( {SD}_{tp} + SC - 1 )}{{ED}_{ij} - {SD}_{ij} + 1} \\ \begin{matrix}else if {SD}_{ij} \geq {SD}_{tp} + \\ SC \& {ED}_{ij} \leq {ED}_{tp} + SC ,\end{matrix} & then {PR}_{ij} = 1 \\ \begin{matrix}else if {SD}_{ij} \geq {SD}_{tp} + \\ SC \& {ED}_{ij} \geq {ED}_{tp} + SC ,\end{matrix} & then {PR}_{ij} = \frac{( {ED}_{tp} + SC ) - {SD}_{ij} + 1 )}{{ED}_{ij} - {SD}_{ij} + 1}\end{matrix}$$

wherein SDᵢⱼ is the start date of time interval i in fiscal period j, SDₜₚ is the start date of time interval t in fiscal period p, EDᵢⱼ is the end date of time interval i in fiscal period j, and EDₜₚ is the end date of time interval t in fiscal period p. Sales cycle SC represents the amount of time (e.g., as a number of days) needed to move an opportunity 310 from the qualifying stage to the closed-won stage. Sales cycle SC may be automatically computed from historical data or manually input.

The win rate W may be manually input or may be computed using historical data for a past time period (e.g., one or more preceding years) as:

$$W = \frac{Total Won Amount for Past Time Period}{Total Closed Amount for Past Time Period}$$

It should be understood that the Won Amount for Past Time Period and the Closed Amount for Past Time Period may be represented in the same units (e.g., monetary value, count of opportunities 310, etc.) as the metric for qualified pipeline 420 described elsewhere herein.

If the pipeline plan is to include open, won, and lost opportunities 310, Rₜ=1. Otherwise, if the pipeline plan is to exclude lost opportunities 310, Rₜ may be computed using historical data for a past time period (e.g., one or more preceding years) as:

$${R}_{t} = Average ( \frac{\begin{matrix}Open Amount in Past Time Period + \\ Won Amount in Past Time Period\end{matrix}}{Qualified Pipeline in Time Period} )$$

It should be understood that the value of Qualified Pipeline in Time Period for a given past time period may be calculated using process 500.

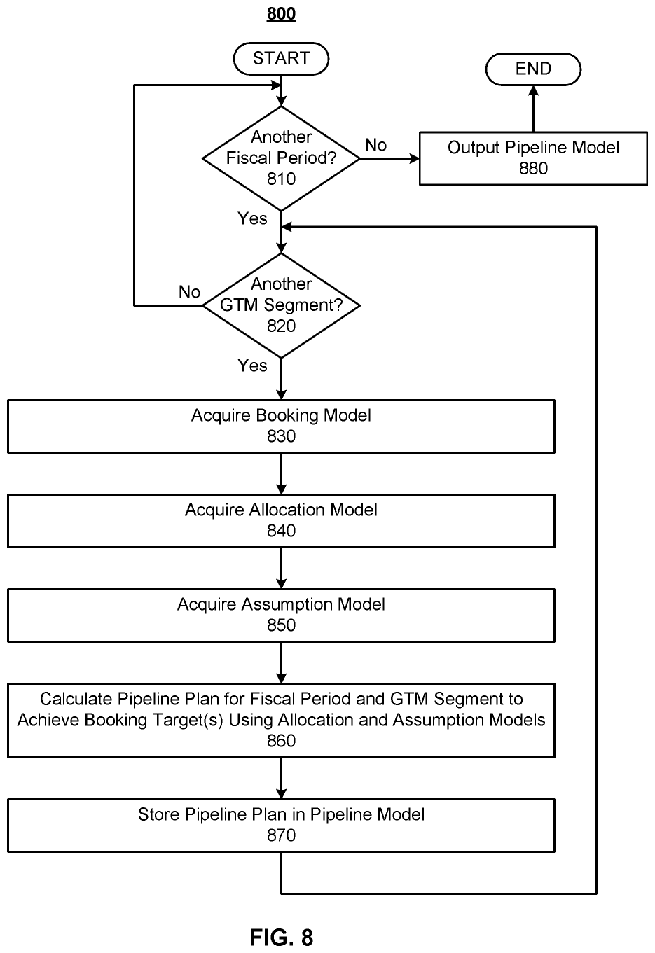

FIG. 8 illustrates a process 800 for calculating a pipeline model, according to an embodiment. Process 800 may be executed by the application, comprising server application 112 and/or client application 132. While process 800 is illustrated as considering one or more fiscal periods, it should be understood that process 800 may be used with any arbitrary time period, including time periods that are unrelated to an entity's particular fiscal year. Fiscal periods are simply being used for illustration, due to their ubiquity and well-understood meaning.

In subprocess 810, process 800 determines whether or not another fiscal period remains to be considered. If another fiscal period remains to be considered (i.e., “Yes” in subprocess 810), process 800 proceeds to subprocess 820. Otherwise, if no fiscal periods remain to be considered (i.e., “No” in subprocess 810), process 800 proceeds to subprocess 880.

In subprocess 820, process 800 determines whether or not another GTM segment 350 remains to be considered. If another GTM segment 350 remains to be considered (i.e., “Yes” in subprocess 820), process 800 proceeds to subprocess 830. Otherwise, if no GTM segments 350 remain to be considered (i.e., “No” in subprocess 820), process 800 returns to subprocess 820. It should be understood that subprocesses 810 and 820 may be performed in reverse order or in parallel.

In subprocess 830, a booking model 720 is acquired for the GTM segment 350 currently under consideration. Booking model 720 may be acquired by receiving one or more inputs from a user via a graphical user interface, retrieving booking model 720 from memory (e.g., database 114), computing or otherwise deriving booking model 720 from historical or other data, or the like. As discussed elsewhere herein, a booking model 720 may be specify one or a plurality of booking targets 725. For purposes of explanation, an example will be provided. In this example, it is assumed that booking targets 725 for fiscal year 2023 (FY2023) for a specific source (e.g., marketing) and GTM segment 350 include: Q1=$60 k; Q2=$90 k; Q3=$90 k; and Q4=$90 k. It is also assumed that the current fiscal period under consideration is Q1 for FY2023, and that each month consists of 30 days, such that each quarter consists of 90 days.

In subprocess 840, an allocation model 740 is acquired for the GTM segment 350 currently under consideration. Allocation model 740 may be acquired by receiving one or more inputs from a user via a graphical user interface, retrieving allocation model 740 from memory (e.g., database 114), computing or otherwise deriving allocation model 740 from historical or other data, or the like. As discussed elsewhere herein, allocation model 740 may specify the allocation percentage for the GTM segment 350 currently under consideration.

In subprocess 850, an assumption model 730 is acquired for the GTM segment 350 currently under consideration. Assumption model 730 may be acquired by receiving one or more inputs from a user via a graphical user interface, retrieving assumption model 730 from memory (e.g., database 114), computing or otherwise deriving assumption model 730 from historical or other data, or the like. In an embodiment, assumption model 730 may be automatically computed based on historical pipeline data (e.g., last two years of pipeline data), but may be overridden by a user who wishes to input the assumptions manually. As discussed elsewhere herein, an assumption model 730 may specify one or a plurality of assumptions 735, such as win rate, sales cycle, average won opportunity size, and/or the like. Returning to the example, it is assumed that assumptions 735 for FY2023 for the specific source and GTM segment 350 include: win rate=50%; and sales cycle=60 days.

In subprocess 860, the pipeline plan is calculated for the fiscal period and GTM segment 350 currently under consideration. The pipeline plan represents the amount of pipeline that should be qualified in the fiscal period to achieve the booking target(s) in the booking model 720, acquired in subprocess 830, using the allocation model 740 and assumption model 730, acquired in subprocesses 840 and 850, respectively. The pipeline plan may be calculated in the manner discussed elsewhere herein. For example, the amount of bookings Aₜₚ may be calculated by looping through all booking periods to sum the amount of bookings (e.g., partial or whole) that each booking period contributes to Aₜₚ. The resulting value of Aₜₚ may then be used to calculate Pₜₚ, wherein t is the fiscal period that is currently under consideration. The calculation of the pipeline plan may account for whether or not the value of Pₜₚ should include the entire qualified pipeline (i.e., open, won, and lost opportunities 310) or just the open and won opportunities 310.

Returning to the example, the pipeline plan for Q1 FY2023 may be calculated based on the FY2023 booking targets. Since the sales cycle is 60 days and Q1 is 90 days, only the first 30 days of Q1 contribute to bookings in Q1, which means that 30/90=1/3 of the Q1 qualified pipeline contributes to the booking target for Q1. The remaining 60 days of Q1 contribute to the bookings in Q2, which means that 60/90=2/3 of the Q1 qualified pipeline contribute to the booking target for Q2. The Q1 qualified pipeline does not contribute to any of the bookings in Q3 or Q4. Based on this distribution of bookings from qualified pipeline 420 in Q1, the pipeline plan for Q1, when counting closed and lost opportunities 310 (i.e., R=1), is:

$${P}_{Q 1 \_ FY 2023} = \frac{\frac{1}{3} \times Q 1 Booking Target + \frac{2}{3} \times Q 2 Booking Target}{W} = \frac{\frac{1}{3} \times \$60 k + \frac{2}{3} \times \$90 k}{0.5} = \$160 k$$

This value will decrease when closed and lost opportunities are not counted. For example, assume that the value of R_{Q1} is calculated to be 90%, based on the average of the ratio of open and won opportunities to qualified pipeline 420, in Q1 of fiscal years 2021 and 2022. In this case, the pipeline plan for Q1 of FY2023 becomes:

P_{Q1_FY2023}=$160 k×0.90=$144 k

In subprocess 870, the pipeline plan may be stored in the pipeline model. For example, the pipeline plan P_{Q1_FY2023} for Q1 of FY2023 may be stored. Then, process 800 returns to subprocess 820 to determine whether or not another GTM segment 350 remains to be considered. Over a plurality of iterations of the loops formed by subprocesses 810 and 820, the pipeline model may comprise a plurality of pipeline plans, each representing a particular fiscal period and GTM segment 350 (e.g., for a particular source). Returning to the example, the pipeline model may comprise a pipeline plan for each of Q1, Q2, Q3, and Q4 of FY2023 for each of one or more GTM segments 350. It should be understood that process 800 may be performed for a plurality of products and/or sources, such that the pipeline model could comprise pipeline plans for each fiscal period, GTM segment 350, product, and/or source. More generally, the pipeline model could comprise pipeline plans, segregated along any one or more dimensions.

In subprocess 880, the pipeline model, comprising one or a plurality of pipeline plans, may be output. This pipeline model may be stored in memory (e.g., database 114), visually represented in a graphical user interface, packaged into a data structure that is sent to another application on platform 110 and/or an external system 150 (e.g., via an API), packaged into a data structure that is otherwise exported from the application, and/or the like.

In the illustrated embodiment of process 800, it is assumed that dimensions, other than the fiscal period and GTM segment 350, are fixed. Process 800 may be individually executed for each value in one of these fixed dimensions (e.g., each product 330, each source, each channel, etc.) to obtain a pipeline model comprising pipeline plans segregated along any combination of dimensions. Alternatively, any combination of dimensions may be considered with subprocesses 810 and 820 (e.g., by adding an additional decision branch for each additional dimension), such that a pipeline plan may be calculated in subprocess 860 and stored in subprocess 870 for any combination of dimensions.

### 3. Graphical User Interface

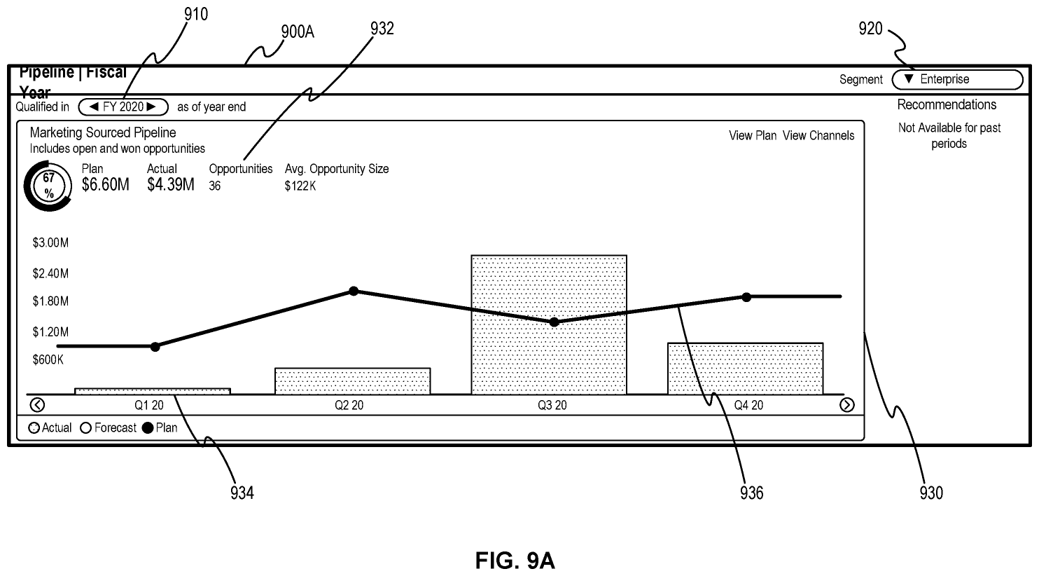

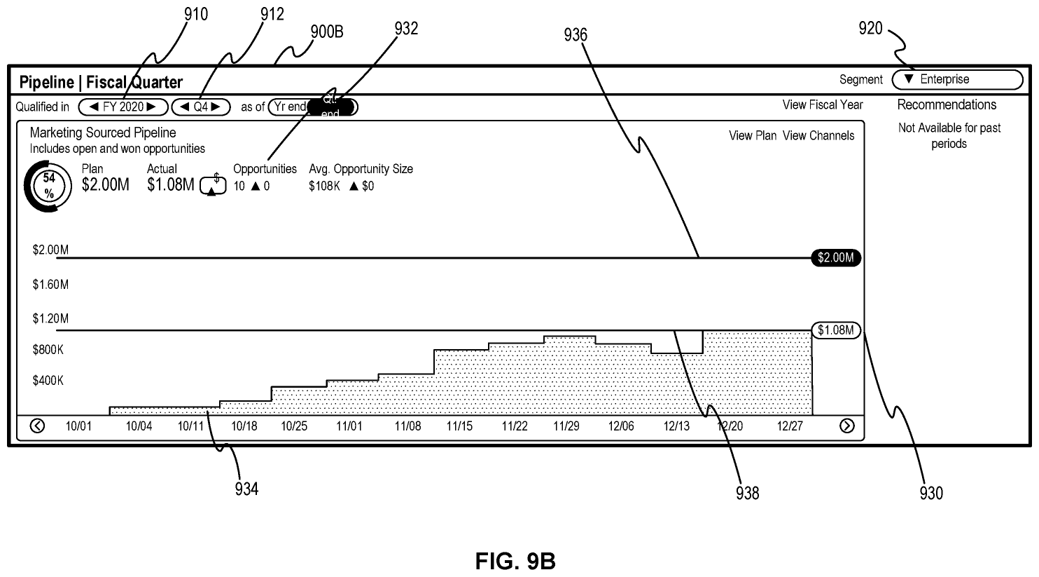

FIGS. 9A-15D represent various example screens of a graphical user interface that may be utilized with one or more of the processes described herein, according to an embodiment. The graphical user interface may be generated by the application (e.g., server application 112 and/or client application 132) in response to actions performed by a user representing an entity 320 (e.g., a B2B business). For example, the user may authenticate with the application, using a user account, to obtain access to a user-specific or entity-specific dashboard which provides navigation through the illustrated screens. It should be understood that when the same reference numeral is used for an element in different screens, any description of that element with reference to any of the screens may apply equally to the same element in any of the other screens.

FIGS. 9A and 9B illustrate screens 900A and 900B, respectively, for viewing qualified pipeline 420 by fiscal period and GTM segment 350, according to an embodiment. Screen 900A comprises an input 910 for selecting a fiscal period (e.g., fiscal year in the illustrated example) and an input 920 for selecting a GTM segment 350. Input 910 may comprise a drop-down menu or slider of all available fiscal periods (e.g., fiscal years), and input 920 may comprise a drop-down menu or slider of all available GTM segments 350. Thus, a user may easily select a combination of fiscal period and GTM segment 350 as dimension values. Screen 900A may be specific to a particular source (e.g., marketing in the illustrated example), which may be selected via user navigation.

Screen 900A may comprise an informational frame 930. Informational frame 930 may comprise a summary area 932 that includes details about qualified pipeline 420 for the selected fiscal period and GTM segment 350. These details may comprise, without limitation, the pipeline plan, the value of the metric of qualified pipeline 420, the number of qualified opportunities 310, the average won opportunity size, and/or a circle chart representing the ratio of qualified pipeline 420 to the pipeline plan for the selected fiscal period and GTM segment 350. Informational frame 930 may also comprise a graph that includes a bar chart 934 of the value of the metric of qualified pipeline 420 for each of a plurality of fiscal sub-periods in the selected fiscal period. In the illustrated example, the selected fiscal period is a fiscal year, and the fiscal sub-periods are the fiscal quarters in the fiscal year. Informational frame 930 may also comprise a line 936 representing the pipeline plan for each of the fiscal sub-periods.

Screen 900B comprises an additional input 912 for selecting a particular fiscal sub-period within the fiscal period selected via input 910. In the illustrated example, the user may use input 912 to select a particular quarter within the fiscal year selected by input 910. A user may navigate from screen 900A to screen 900B by selecting the bar chart 934 associated with a particular fiscal sub-period and/or via one or more other inputs in screen 900A.

In screen 900B, informational frame 930 is updated to show information for the selected fiscal sub-period. In particular, summary area 932 is updated to include details about qualified pipeline 420 for the selected fiscal sub-period and GTM segment 350, and informational frame 930 now includes a bar chart 934 for a plurality of fiscal sub-sub-periods (e.g., fiscal weeks within the selected fiscal quarter in the illustrated example). In the illustrated example, the pipeline plan is only as granular as one quarter. Thus, line 936 becomes a flat line representing the pipeline plan for the entire fiscal sub-period. It should be understood that, if the pipeline plan were to be defined at a more granular level (e.g., monthly, weekly, or daily), line 936 may instead connect points representing the values of those pipeline plans, as in screen 900A. Informational frame 930 may also comprise a line 938 representing qualified pipeline 420 at the end of the selected fiscal sub-period.

It should be understood that a user may continue to drill down into fiscal periods until the most granular fiscal period is reached. For example, from screen 900B, the user could navigate to a similar screen for a selected fiscal sub-sub-period (e.g., a particular week) if qualified pipeline 420 is calculated on a weekly basis. From there, the user could navigate to a similar screen for a selected sub-sub-sub-period (e.g., a particular day) if the metric of qualified pipeline is calculated on a daily basis. In each case, the user may select a more granular fiscal period by selecting a bar chart 934 for that period and/or via one or more other inputs. In addition, in each case, another input, similar to inputs 910 and 912, may be added to the screen for each additional level of fiscal periods.

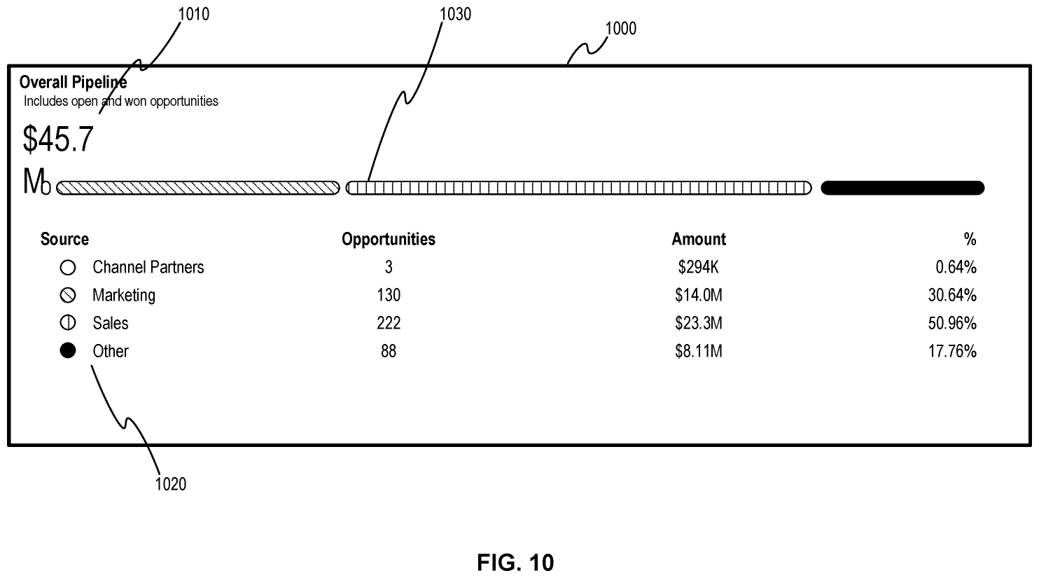

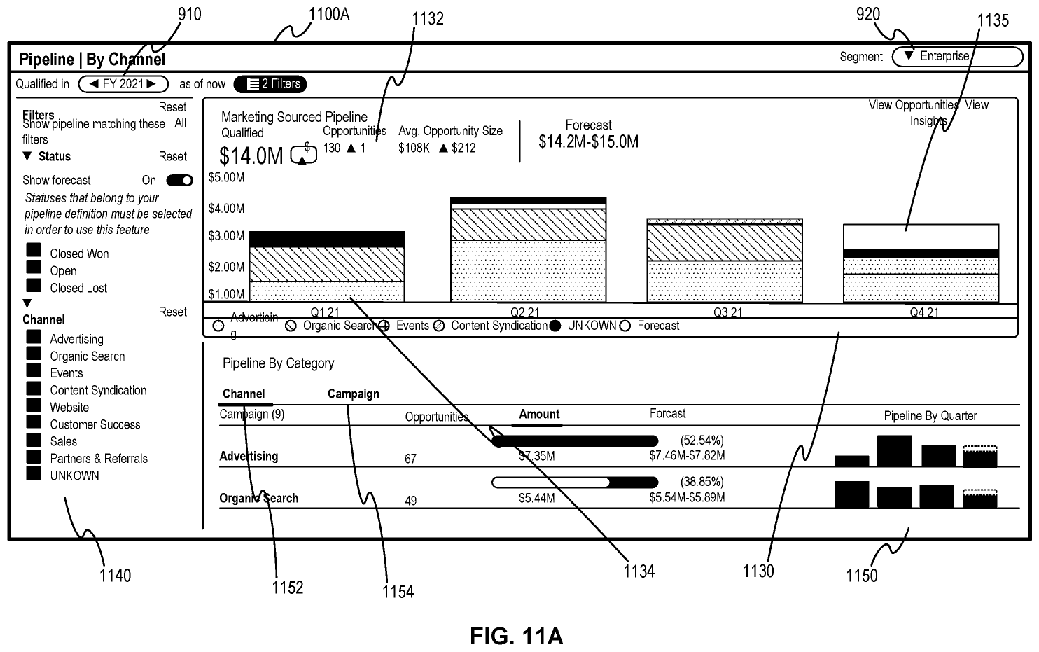

FIG. 10 illustrates a screen 1000 for viewing statistics for the overall qualified pipeline 420 across all sources and GTM segments 350 for a specific fiscal period, according to an embodiment. The statistics may comprise a total value 1010 of the metric of qualified pipeline 420 for the specific fiscal period. Additional statistics may be presented in a table 1020 that includes rows for each source. As illustrated, each row may comprise the name of the source next to a color coding for the source, the number of qualified opportunities 310 within the specific fiscal period, the value of the metric of qualified pipeline 420 in the specific fiscal period, and the percentage of qualified pipeline 420 that was derived from the source in the specific fiscal period. In addition, screen 1000 may comprise a color-coded graphical representation 1030 of the contribution of each source to the total value 1010 of the metric of qualified pipeline 420, using the color coding associated with the name of each source in table 1020. In other words, table 1020 also acts as a legend for graphical representation 1030.

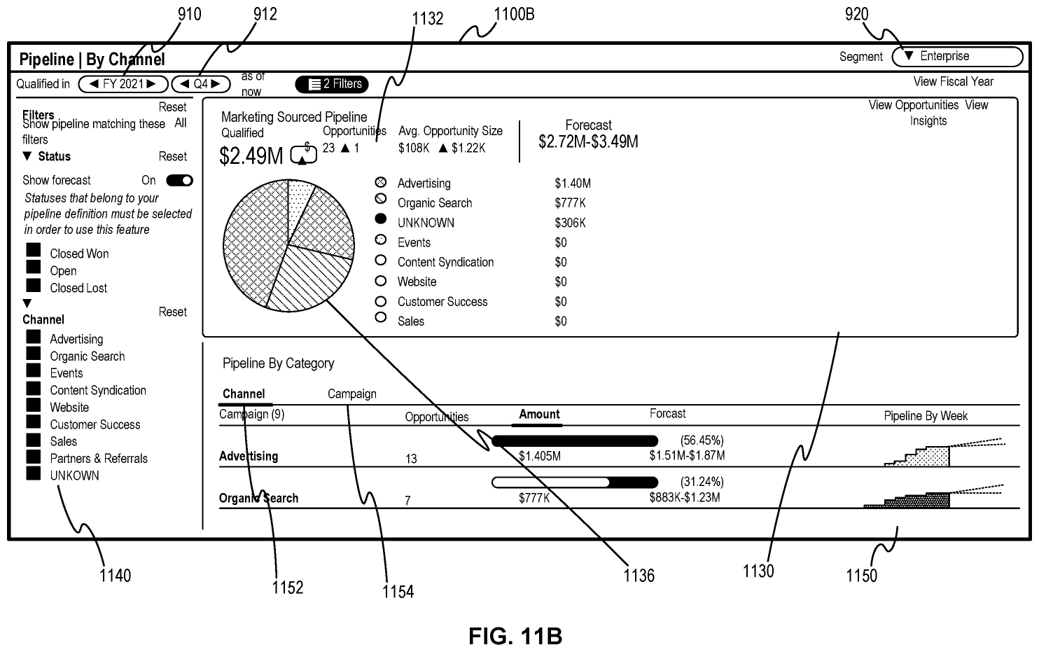

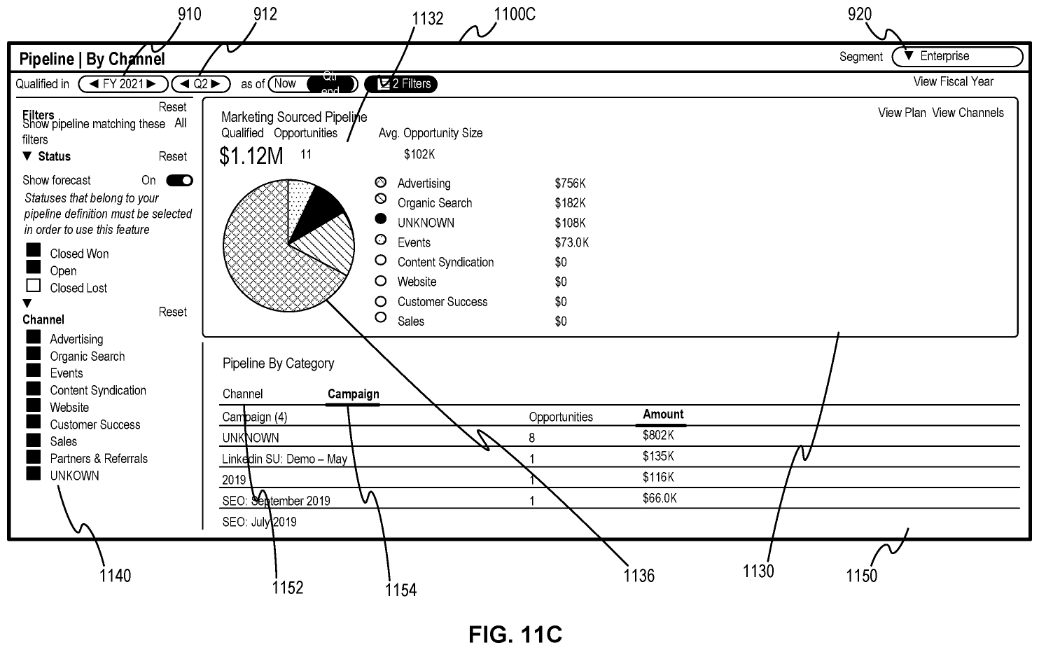

FIGS. 11A-11C illustrate screens 1100A-1100C, respectively, for viewing qualified pipeline 420 by channel, fiscal period, and GTM segment 350, according to an embodiment. Screen 1100A comprises an input 910 for selecting a fiscal period (e.g., fiscal year in the illustrated example) and an input 920 for selecting a GTM segment 350.

Screen 1100A may comprise an informational frame 1130. Informational frame 1130 may comprise a summary area 1132 that includes details about qualified pipeline 420 for the selected fiscal period and GTM segment 350. These details may comprise, without limitation, the value of the metric of qualified pipeline 420, the number of qualified opportunities 310, the average won opportunity size, and/or a forecasted value of the metric of qualified pipeline 420 for the selected fiscal period and GTM segment 350. The forecasted value of the metric of qualified pipeline 420 may be represented as a range from a base-case forecast to a best-case forecast, as described elsewhere herein. Informational frame 1130 may also comprise a graph that includes a stacked bar chart 1134 of the value of the metric of qualified pipeline 420 for each of a plurality of fiscal sub-periods in the selected fiscal period. Stacked bar chart 1134 is similar to bar chart 934, except that each stacked bar chart 1134 is divided proportionately and with color coding into the individual channels of qualified pipeline 420 for the respective fiscal sub-period. In the illustrated example, the selected fiscal period is a fiscal year, and the fiscal sub-periods are the fiscal quarters in the fiscal year. In the event that the selected fiscal period is not yet complete (i.e., the end of the selected fiscal period is in the future), stacked bar chart 1134 for each fiscal sub-period that has not yet ended may include a component 1135 representing the unfulfilled portion of the forecasted value of the metric of qualified pipeline 420 for that fiscal sub-period.

Screen 1100A may comprise a filter frame 1140. Filter frame 1140 comprises one or more toggle inputs (e.g., slider, radio button, checkbox, etc.) representing selectable filters. The selectable filters may comprise status filters and channel filters. Examples of status filters are open opportunities 310, closed-won opportunities 310, and closed-lost opportunities 310. If a user toggles a status filter on, opportunities 310 with that status will be included in the displayed data. Conversely, if a user toggles a status filter off, opportunities 310 with that status will be excluded from the displayed data. The channel filters may comprise a selectable filter for each channel. If a user toggles a channel filter on, opportunities 310 associated with that channel will be included in the displayed data. Conversely, if a user toggles a channel filter off, opportunities 310 associated with that channel will be excluded from the displayed data. Filter frame 1140 may also comprise a toggle input for toggling forecasting on or off. If forecasting is turned off, the forecasted value of the metric of qualified pipeline 420 may be excluded from informational area 1132 and forecast component 1135 may be excluded from stacked bar charts 1134.

Screen 1100A may comprise a category frame 1150. Category frame 1150 may comprise a tab 1152 for channels and a tab 1154 for campaigns. FIG. 11A illustrates channels tab 1152, which may comprise a table having rows that include additional information for each of the channels. For example, this additional information may comprise, for each channel, the name of the channel, the number of opportunities 310 associated with the channel, the value of the metric of qualified pipeline 420 associated with the channel, the forecast associated with the channel, bar charts of the metric of qualified pipeline 420 associated with the channel, and/or the like for each fiscal sub-period for the selected fiscal period and GTM segment 350.

Screen 1100B comprises an additional input 912 for selecting a particular fiscal sub-period within the fiscal period selected via input 910. In the illustrated example, the user may use input 912 to select a particular quarter within the fiscal year selected by input 910. A user may navigate to screen 1100B from screen 1100A by selecting the bar chart 1134 associated with a particular fiscal sub-period and/or via one or more other inputs.

In screen 1100B, informational frame 1130 is updated to show information for the selected fiscal sub-period. In particular, information area 1132 is updated to include details about the value of the metric of qualified pipeline 420 for the selected fiscal sub-period and GTM segment 350, and informational frame 1130 now includes a color-coded pie chart 1136 that depicts the proportion of qualified pipeline 420 that is associated with each channel, along with a legend that provides the color coding for each channel and the value of the metric of qualified pipeline associated with each channel.

In screen 1100B, category frame 1150 may also be updated. In particular, the additional information in the table may be updated to reflect data about the selected fiscal sub-period. For example, this additional information may comprise, for each channel, the name of the channel, the number of opportunities 310 associated with the channel, the value of the metric of qualified pipeline 420 associated with the channel, the forecast associated with the channel, and/or bar charts of qualified pipeline 420 associated with the channel for each fiscal sub-sub-period for the selected fiscal sub-period and GTM segment 350, along with a forecasted range (e.g., defined by base-case and best-case forecasts) if the selected fiscal sub-period has not yet ended.

In the illustrated example, the user may select campaign tab 1154 to transition from screen 1100B to screen 1100C. In screen 1100C, category frame 1150 has been updated to comprise a table having rows that include additional information for each campaign associated with qualified pipeline 420 for the selected fiscal sub-period and GTM segment 350. The additional information may comprise, for each campaign, the name of the campaign, the number of opportunities 310 produced by the campaign, the value of the metric of qualified pipeline 420 derived from the campaign, and/or the like for the selected fiscal sub-period and GTM segment 350.

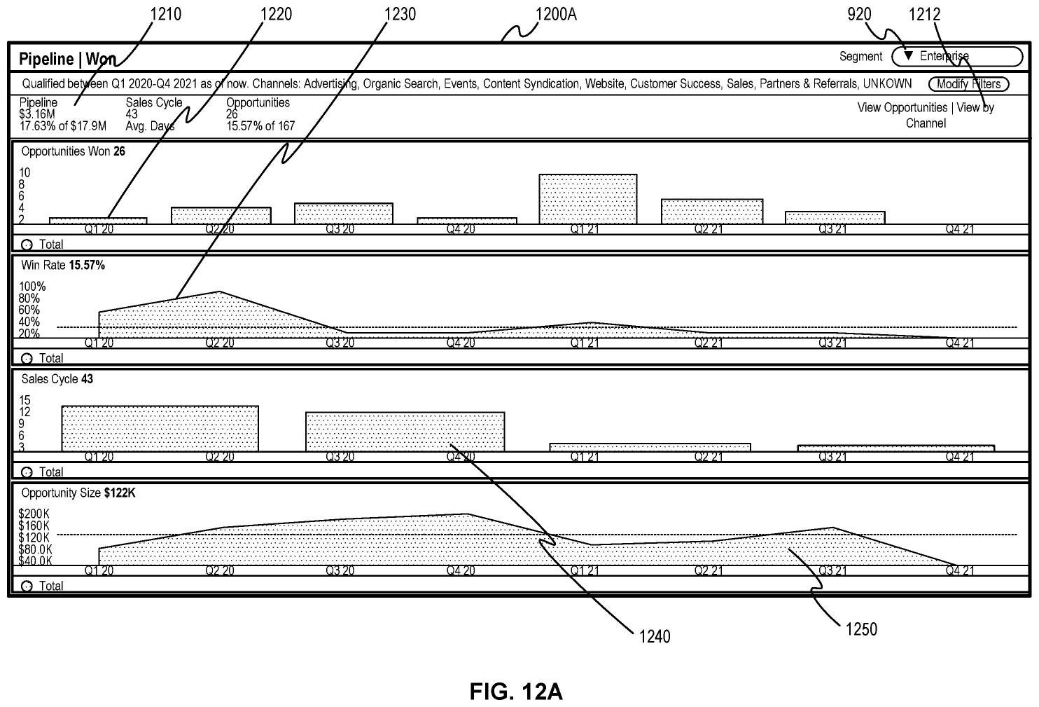

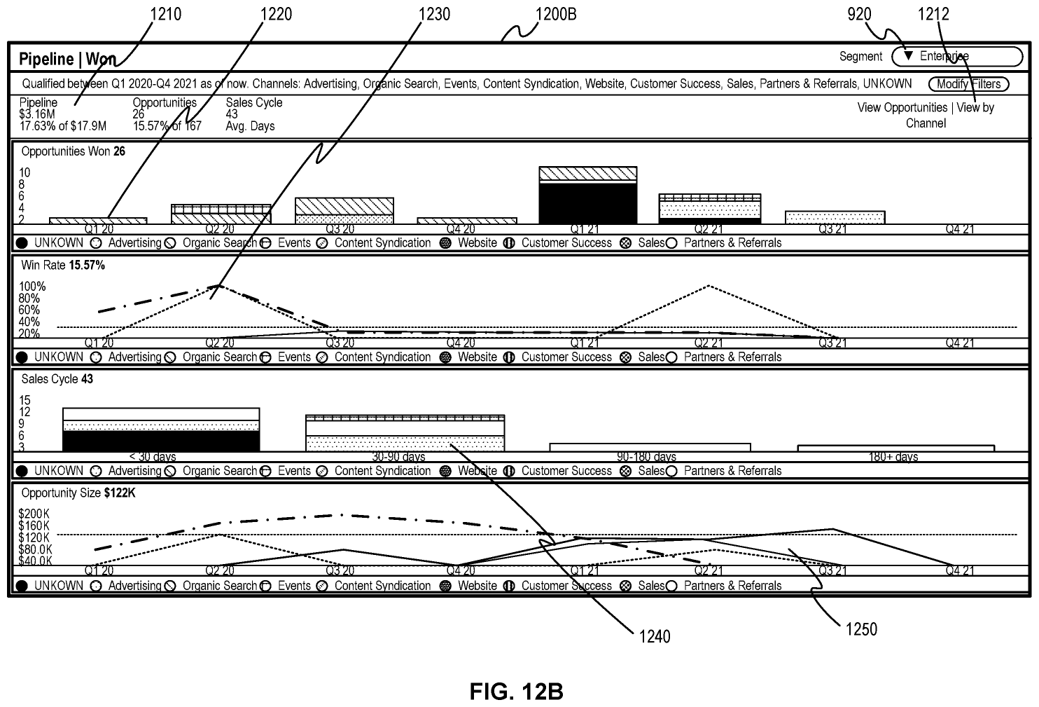

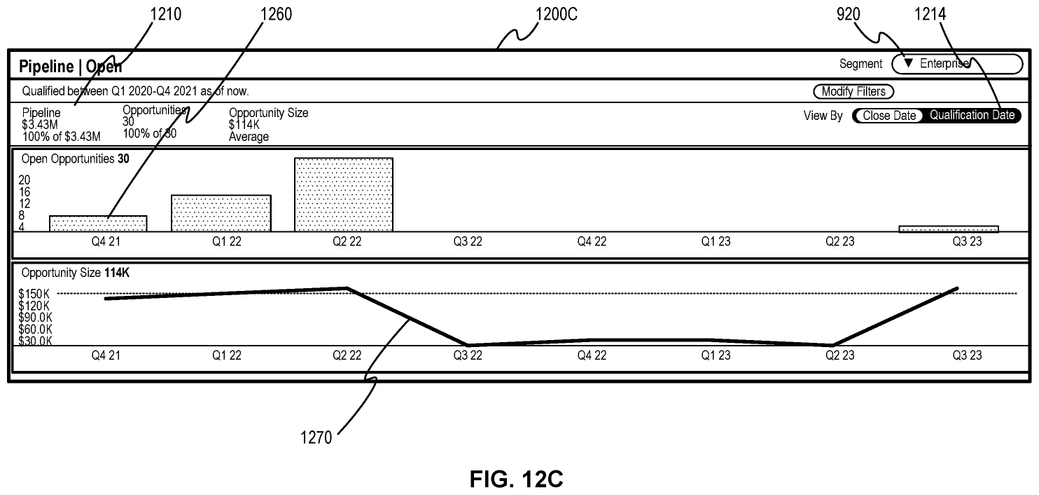

FIGS. 12A-12C illustrates screens 1200A-1200C, respectively, for viewing various statistics related to qualified pipeline 420, according to an embodiment. Each of screens 1200A-1200C display data along one or more dimensions. In screens 1200A and 1200B, the dimensions are a selected time period (e.g., a custom time period of two fiscal years), a GTM segment 350 (e.g., enterprise), and a set of channels. In screen 1200C, the dimensions are a selected time period and a GTM segment 350.

Each of screens 1200A-1200C may comprise an informational area 1210, which may include statistics in the dimension(s). These statistics may comprise the monetary value of qualified pipeline 420, the number of opportunities 310 in qualified pipeline 420, the average sales cycle, the average won opportunity size, and/or the like.

Each of screens 1200A-1200C may comprise a set of graphs that visually depicts statistics in the other selected dimension(s). For example, in screens 1200A and 1200B, graph 1220 visually depicts the number of opportunities 310 that are won over each sub-period (e.g., quarter) in the selected time period, graph 1230 visually depicts the win rate over each sub-period in the selected time period, graph 1240 visually depicts the number of opportunities 310 in each of a plurality of sales-cycle buckets (e.g., less than 30 days, 30 to 90 days, 90 to 180 days, and greater than 180 days), and graph 1250 visually depicts the average opportunity size over each sub-period in the selected time period. In screen 1200C, graph 1260 visually depicts the number of open opportunities 310 in each sub-period in the selected time period, and graph 1270 visually depicts the average opportunity size over each sub-period in the selected time period. It should be understood that graphs 1220-1270 may utilize any type of graph that is appropriate for the statistic being depicted, including bar charts, line graphs, and/or the like.

Screens 1200A and 1200B may comprise a toggle input 1212 that toggles between an overall view and a by-channel view. Screen 1200A depicts the overall view, and screen 1200B depicts the by-channel view. As illustrated, in the by-channel view of screen 1200B, each of graphs 1220-1250 depicts the statistics by channel. Conversely, in the overall view of screen 1200A, graphs 1220-1250 do not depict the statistics aggregated across all channels.

Screen 1200C may comprise a toggle input 1214 that toggles between viewing the statistics for opportunities 310 that are closed in each sub-period and opportunities 310 that are qualified in each sub-period. Thus, a user can easily and quickly switch between these two views.

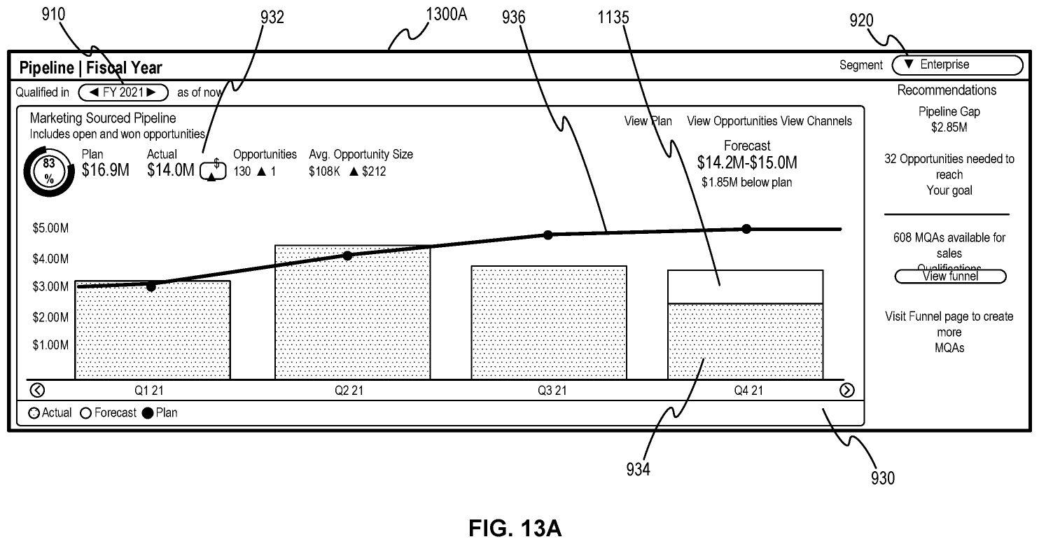

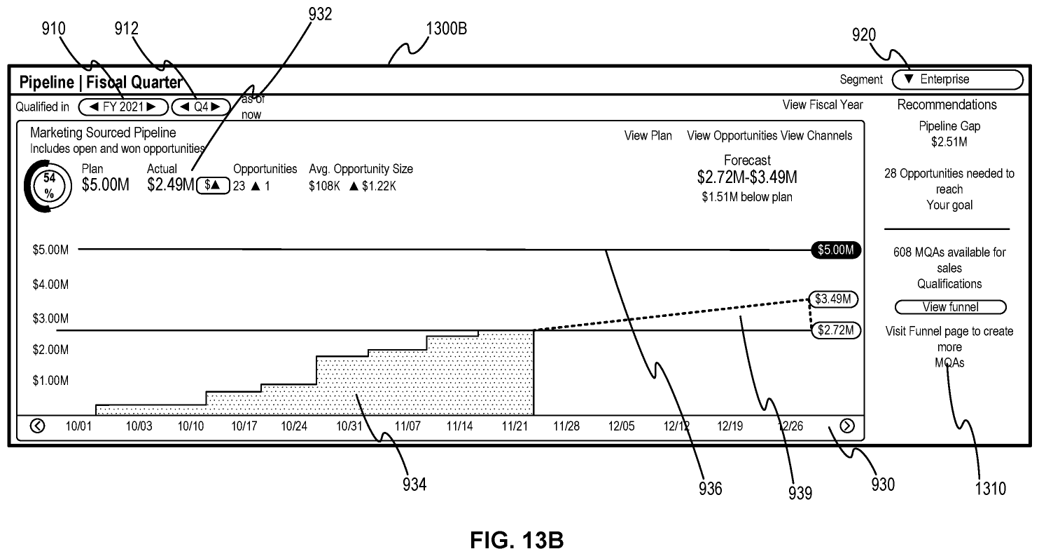

FIGS. 13A and 13B illustrate screens 1300A and 1300B, respectively, for viewing qualified pipeline 420 with forecasting, according to an embodiment. Screen 1300A depicts data for a fiscal year, whereas screen 1300B depicts data for a fiscal quarter in the fiscal year depicted in screen 1300A. A user may navigate from screen 1300A to screen 1300B by selecting the bar chart 934 associated with a particular fiscal sub-period (e.g., quarter) and/or via one or more other inputs in screen 900A.

As discussed elsewhere herein, a user may toggle forecasting on and off. When forecasting is turned on and the selected time period has not yet ended, a forecasted component 1135 may be added to bar chart 934 for any sub-period that has not yet ended. As illustrated in screen 1300B, the missing portion of the selected time period may be represented by a triangle 939 representing the forecasted range (e.g., defined by base-case and best-case forecasts) for the remainder of the selected time period. In addition, a forecasted range may be added to summary area 932.

When forecasting is turned on, screens 1300A and 1300B may comprise a recommendations frame 1310. Recommendations frame 1310 may comprise one or more recommendations based on the forecast. For example, recommendations frame 1310 may display the difference between the current value of the metric of qualified pipeline and the pipeline plan, the number of opportunities 310 that need to be won to make up the difference (e.g., calculated as the difference divided by the average won opportunity size in the relevant assumption model 730), a number of marketing-qualified leads 620 that are available, with a hyperlink to screen(s) for engaging or performing actions other with those leads, a link to a screen representing the sales funnel to create more marketing-qualified leads 620, and/or the like.

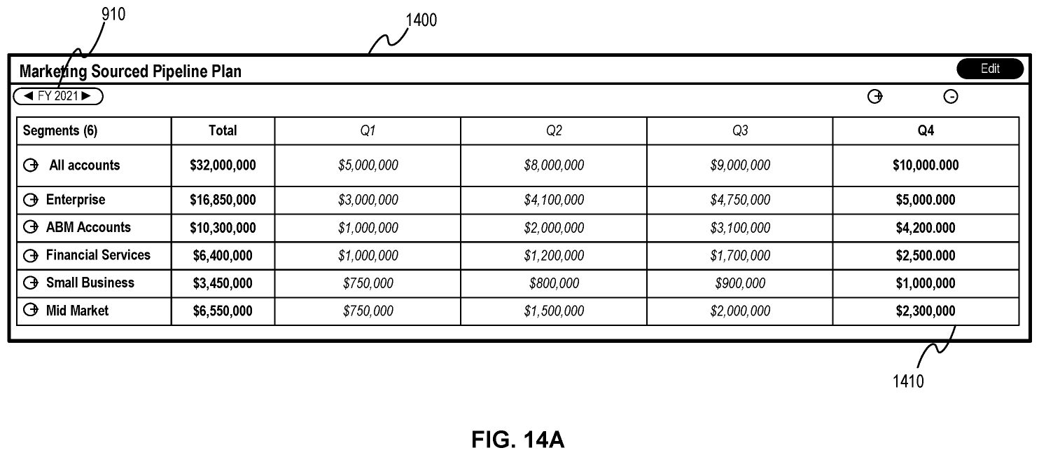

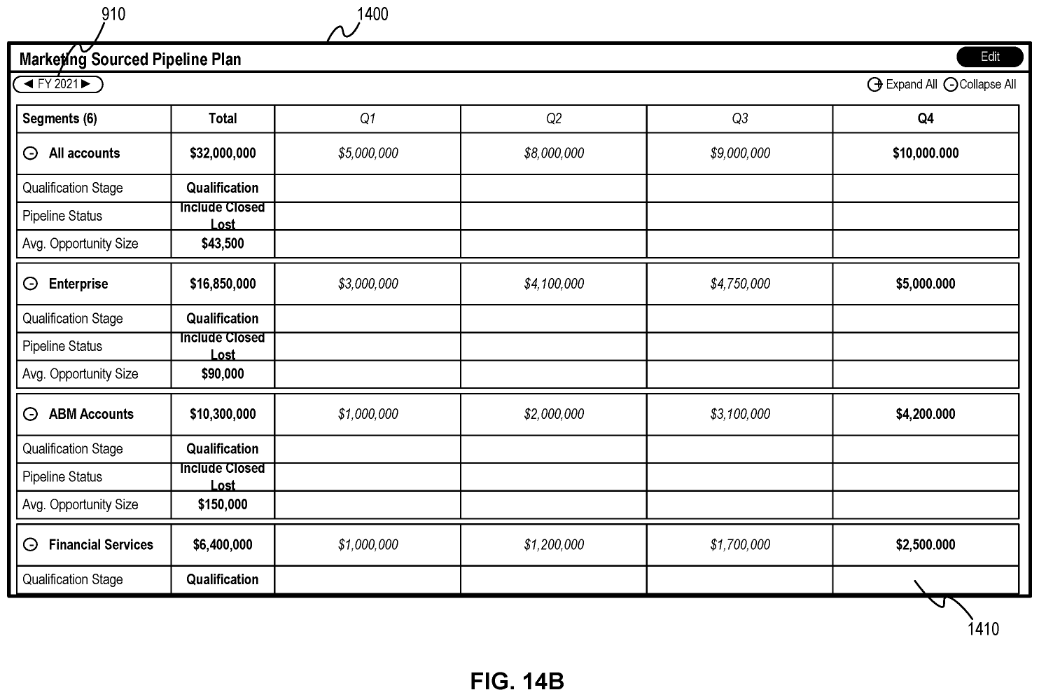

FIGS. 14A and 14B illustrate a screen 1400 for viewing a pipeline model in collapsed and expanded views, respectively, according to an embodiment. Screen 1400 comprises a table 1410 that lists pipeline plans for the time period (e.g., fiscal year) selected by a user via input 910. The rows in table 1410 may represent each GTM segment 350. Each row may comprise, for the represented GTM segment 350, the name of the GTM segment 350, the total pipeline plan for the selected time period and represented GTM segment 350, and the pipeline plan for each sub-period in the selected time period for the represented GTM segment 350. Table 1410 may also comprise a row representing the totals for all GTM segments 350. In the expanded view of screen 1400, illustrated in FIG. 14B, each row may be expanded to display the qualifying stage, pipeline setting (e.g., whether or not to include closed-lost opportunities 310), and average opportunity size for each row's pipeline plan.

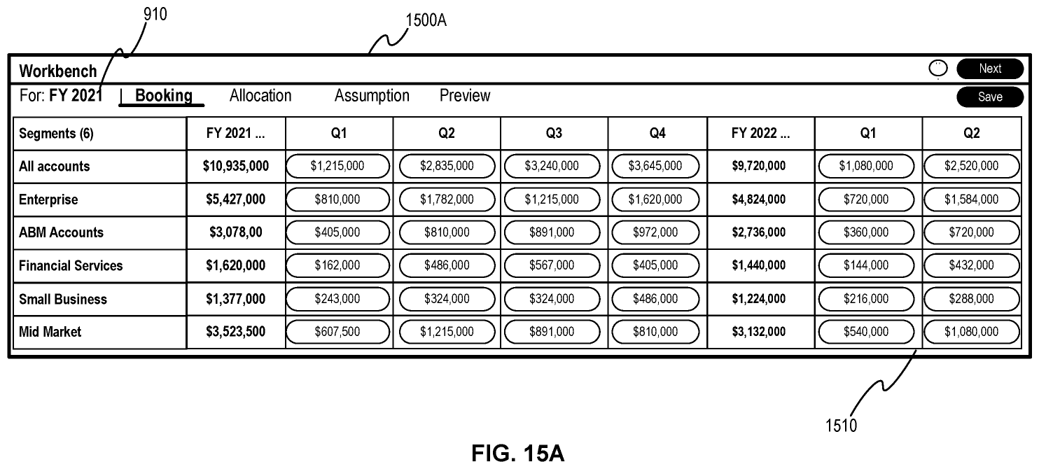

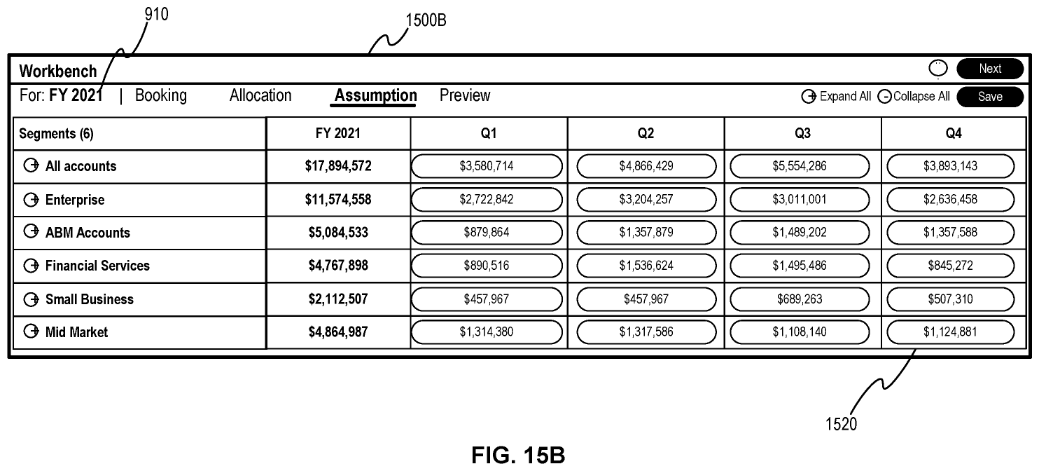

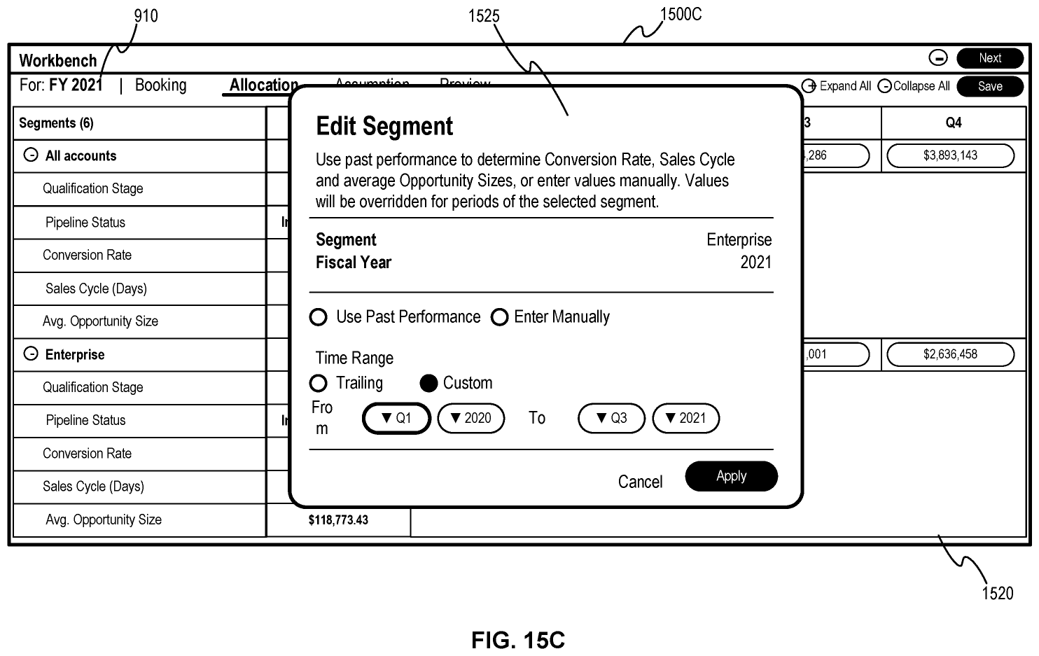

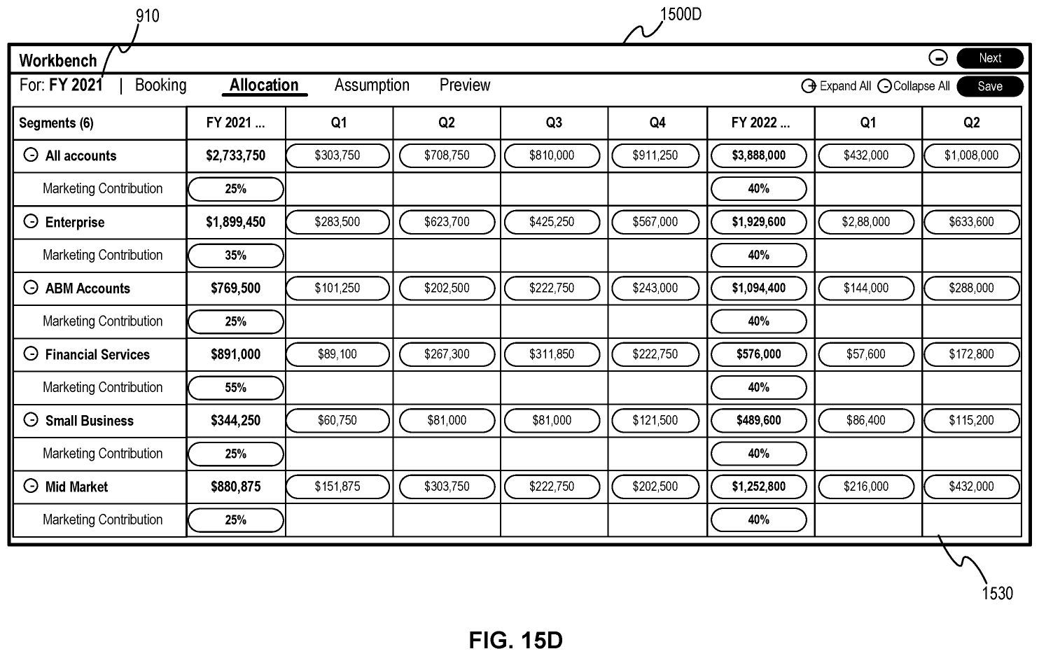

FIGS. 15A-15D illustrate screens for viewing and/or defining various models described herein, according to an embodiment. In particular, screen 1500A may be used to view and/or define a booking model 720, screen 1500B may be used to view and/or define an assumption model 730, and screen 1500C may be used to view and/or define an allocation model 740.

Screen 1500A, illustrated in FIG. 15A, comprises input 910 for selecting a time period, and a table 1510 that displays, for each GTM segment 350, booking targets 725 for each sub-period in the selected time period. Booking targets 725 may be computed automatically and/or manually input. For example, each row or cell in table 1510 may comprise an input for computing or inputting a booking target 725.

Screen 1500B, illustrated in FIGS. 15B and 15C, comprises input 910 for selecting a time period, and a table 1520 that displays, for each GTM segment 350, assumptions 735 for each sub-period in the selected time period. Assumptions 735 may be computed automatically and/or manually input. For example, each row or cell in table 1520 may comprise an input for computing or inputting an assumption 735. Each row in table 1520 of screen 1500B may be expandable. As illustrated in FIG. 15C, when expanded, each row may display the qualifying stage, pipeline setting, win rate, sales cycle, average won opportunity size, and/or the like for the respective GTM segment 350.

FIG. 15C illustrates screen 1500B after a user has opened a dialog for a given GTM segment 350 via an input associated with the row for that GTM segment 350 in table 1520. As illustrated, the dialog may enable a user to have the application automatically compute assumptions 735 based on a custom past time period, or manually enter assumptions 735.

Screen 1500C, illustrated in FIG. 15D, comprises input 910 for selecting a time period, and a table 1530 that displays, for each GTM segment 350, an allocation of one or more sources to each GTM segment 350 for the selected time period. The allocations may be computed automatically and/or manually input. For example, each row in table 1530 may comprise an input for computing or inputting an allocation.

It should be understood that any of the illustrated screens that are based on a fiscal period may represent any level of fiscal period, as long as data is available at that level of granularity. For example, screens displaying data for a fiscal year may be easily adapted to display data for a fiscal quarter, month, week, day, and/or the like. Thus, it should be understood that any of the illustrated screens may be utilized at any level of fiscal period, even if illustrated for a specific level of fiscal period. In addition, any of the illustrated screens may include filter frame 1140 to filter the displayed data and/or recommendations frame 1310. These frames may be expandable by the user when desired for use and collapsible by the user when desired to be hidden. Furthermore, the displayed data in the illustrated screens may be aggregated and/or filtered along any one or more dimensions such as two or more, including potentially all, GTM segments 350, any user-specified or custom time period, and/or the like.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
set a qualifying stage that divides a pipeline, comprising a plurality of stages, into an unqualified pipeline and a qualified pipeline;
set one or more times;
for each of the one or more times,
determine a set of opportunities that had reached the qualifying stage at that time,
calculate a metric of the qualified pipeline based on the determined set of opportunities, and
store the calculated metric in memory; and
perform one or more actions based on at least one of the stored calculated metrics.

2. The method of claim 1, wherein any opportunities, which reached the qualifying stage at the time but are currently in the unqualified pipeline, are excluded from the set of opportunities.

3. The method of claim 1, wherein the one or more times are a plurality of times.

4. The method of claim 3, wherein the plurality of times comprises a plurality of times that are separated by fixed time intervals.

5. The method of claim 3, wherein the plurality of times represents one or more fiscal periods.

6. The method of claim 5, wherein the one or more fiscal periods are a plurality of fiscal periods that comprise at least one first fiscal period at a first level of granularity and a plurality of second fiscal periods at a second level of granularity that has greater granularity than the first level, wherein the at least one first fiscal period is composed of the plurality of second fiscal periods, wherein the one or more actions comprise generating a graphical user interface that comprises a first screen and a second screen, wherein the first screen visually represents the stored calculated metric for the at least one fiscal period and provides navigation to the second screen, and wherein the second screen visually represents the stored calculated metric for each of the plurality of second fiscal periods.

7. The method of claim 6, wherein the at least one first fiscal period extends to a future time, such that at least one of the plurality of second fiscal periods also extends to the future time, wherein the method further comprises using the at least one hardware processor to forecast the metric of the qualified pipeline at the future time, and wherein the first screen and the second screen visually represent the forecasted metric of the qualified pipeline at the future time.

8. The method of claim 7, wherein forecasting the metric of the qualified pipeline at the future time comprises calculating a minimum value of the metric of the qualified pipeline at the future time and a maximum value of the metric of the qualified pipeline at the future time, and wherein the first screen and the second screen visually represent a range between the minimum value and the maximum value.

9. The method of claim 1, further comprising using the at least one hardware processor to receive a plurality of opportunities from a customer relationship management (CRM) system via at least one network, wherein the set of opportunities is determined from the received plurality of opportunities.

10. The method of claim 9, wherein each of the plurality of opportunities comprises a set of one or more stages associated with the opportunity, and, for each of the one or more stages, a time at which the opportunity entered that stage, and wherein determining the set of opportunities comprises, for each of the plurality of opportunities:
generating a time series of the one or more stages associated with that opportunity based on the time at which the opportunity entered each of the one or more stages; and
determining whether or not the opportunity had reached the qualifying stage at the time based on the time series.

11. The method of claim 1, wherein each of the plurality of opportunities comprises a set of one or more stages associated with the opportunity, and wherein determining the set of opportunities comprises, for each stage in the set of one or more stages:
if the stage is not one of the plurality of stages,
map the stage to one of the plurality of stages or to a position in the pipeline based on a stored mapping.

12. The method of claim 1, wherein the set of opportunities is stored in a relational database, and wherein calculating the metric of the qualified pipeline comprises executing a single query that sums an attribute, stored in the relational database, for each opportunity in the set of opportunities.

13. The method of claim 12, wherein the attribute is a monetary value.

14. The method of claim 12, wherein the single query groups the metric by one or more dimensions.

15. The method of claim 12, wherein the single query excludes opportunities from the set of opportunities that are associated with a current stage that is in the unqualified pipeline.

16. The method of claim 1, wherein the metric of the qualified pipeline comprises one or more of a total monetary value, average monetary value, or count of the determined set of opportunities.

17. The method of claim 1, wherein calculating the metric of the qualified pipeline comprises calculating the metric of the qualified pipeline in one or more dimensions, other than time.

18. The method of claim 17, wherein the one or more dimensions comprise go-to-market segments.

19. The method of claim 17, wherein the one or more dimensions comprise products.

20. The method of claim 1, wherein the one or more actions comprise tracking a performance metric of the pipeline.

21. The method of claim 20, wherein the performance metric comprises one or more of an opportunity win rate, a pipeline win rate, or an average sales cycle.

22. The method of claim 1, further comprising using the at least one hardware processor to:
for each opportunity in the determined set of opportunities for the one or more times, determine a buyer persona associated with the opportunity, wherein the buyer persona comprises a job level and a job function; and
order the determined buyer personas based on a frequency of each determined buyer persona within the determined set of opportunities for the one or more times.

23. The method of claim 1, wherein the one or more actions comprise forecasting the metric of the qualified pipeline at a future time.

24. The method of claim 23, wherein the one or more times comprises a current time, and wherein forecasting the metric of the qualified pipeline at a future time comprises:
determining a number N of predefined time intervals between the current time and the future time;
determining a growth rate G for the predefined time intervals; and
calculating the metric of the qualified pipeline at the future time according to
F=G×N+B,
wherein F is the metric of the qualified pipeline at the future time, and
wherein B is the calculated metric, stored in memory, for the current time.

25. The method of claim 24, wherein determining the growth rate G comprises:
executing each of a plurality of independent forecasting models that output a value for the growth rate G; and
determining a single value for the growth rate G from the values output by the plurality of independent forecasting models.

26. The method of claim 24, wherein determining the growth rate G comprises:
executing each of a plurality of independent forecasting models that output a value for the growth rate G;
identifying a minimum value for the growth rate G from the values output by the plurality of independent forecasting models;
identifying a maximum value for the growth rate G from the values output by the plurality of independent forecasting models;
calculating a base-case value of the metric F of the qualified pipeline at the future time using the minimum value for the growth rate G; and
calculating a best-case value of the metric F of the qualified pipeline at the future time using the maximum value for the growth rate G.

27. The method of claim 24, wherein determining the growth rate G comprises calculating the growth rate G using a seasonal average that calculates an average actual growth rate for the predefined time intervals within a time period, corresponding to a time period between the current time and the future time in a current fiscal year, in one or more prior fiscal years.

28. The method of claim 24, wherein determining the growth rate G comprises calculating the growth rate G using a moving average that calculates an average actual growth rate for the predefined time intervals within a time period, corresponding to a time period between the current time and the future time in a current fiscal period, in one or more prior fiscal periods.

29. The method of claim 24, wherein determining the growth rate G comprises calculating the growth rate G using a linear drift that calculates an average actual growth rate for the predefined time intervals within at least one past time period.

30. The method of claim 23, wherein the one or more times comprise a current time, and wherein forecasting the metric of the qualified pipeline at a future time comprises:
determining a number N of predefined time intervals between the current time and the future time; and,
for each channel c from a plurality of channels C,
determining a growth rate G_{c} for the predefined time intervals for the channel c;
determining a growth rate G for the predefined time intervals for the qualified pipeline; and
calculating the metric of the qualified pipeline at the future time for the channel c according to
$${F}_{c \_ min} = \frac{min {G}_{c} + max {G}_{c}}{{\sum }_{i = 0}^{C} min {G}_{i} + {\sum }_{i = 0}^{C} max {G}_{i}} \times min ( G \times N ) + {B}_{c} \\ {F}_{c \_ max} = \frac{min {G}_{c} + max {G}_{c}}{{\sum }_{i = 0}^{C} min {G}_{i} + {\sum }_{i = 0}^{C} max {G}_{i}} \times max ( G \times N ) + {B}_{c}$$
wherein min is a function that finds a minimum value,
wherein max is a function that finds a maximum value,
wherein F_{c_min} is a minimum value of the qualified pipeline for channel c at the future time,
wherein F_{c_max} is a maximum value of the qualified pipeline for channel c at the future time, and
wherein B_{c} is the calculated metric, stored in memory, for the current time for channel c.

31. The method of claim 1, wherein the one or more actions comprise generating a pipeline plan for one or more time periods, preceding a future time, for achieving a booking target at the future time.

32. The method of claim 31, wherein the pipeline plan comprises a value of the metric of the qualified pipeline.

33. The method of claim 31, wherein the pipeline plan is generated based on the booking target and one or more parameters derived from the at least one stored calculated metric.

34. The method of claim 33, wherein the one or more parameters comprise one or more of a win rate, a sales cycle, or an average won opportunity size.

35. The method of claim 31, wherein the pipeline plan is generated based on a planning model that comprises at least one booking model that defines the booking target, at least one assumption model that defines one or more parameters derived from the at least one stored calculated metric, and at least one allocation model that defines a proportion of the metric of the qualified pipeline that is allocated to each of a plurality of sources.

36. The method of claim 31, wherein generating the pipeline plan comprises calculating the pipeline plan Pₜₚ for a time interval t in a fiscal period p for a source according to:
$${P}_{tp} = \frac{{A}_{tp} \times {R}_{t}}{W}$$
wherein Aₜₚ is an amount of bookings allocated to the source for time interval t in fiscal period p,
wherein Rₜ is a tracking ratio, and
wherein W is a win rate for the source.

37. The method of claim 36, wherein the amount of bookings Aₜₚ is computed as:
$${A}_{tp} = {\sum }_{i , j}^{t , p} ( {FB}_{ij} \times {PR}_{ij} \times {PCT}_{ij} )$$
wherein FBᵢⱼ is a total amount of bookings for time interval i in fiscal period j,
wherein PRᵢⱼ is a proportional ratio for time interval i in fiscal period j, and
wherein PCTᵢⱼ is a percentage of the total amount of bookings that is allocated to the source for time interval i in fiscal period j.

38. The method of claim 37, wherein the proportional ratio PRᵢⱼ is computed based on a sales cycle between the qualifying stage and one of the plurality of stages representing a closed and won opportunity.

39. The method of claim 38, wherein the proportional ratio PRᵢⱼ is computed as:
$$\begin{matrix}\begin{matrix}if {SD}_{ij} < {SD}_{tp} + \\ SC \& {ED}_{ij} < {ED}_{tp} + SC ,\end{matrix} & then {PR}_{ij} = \frac{{ED}_{ij} - ( {SD}_{tp} + SC - 1 )}{{ED}_{ij} - {SD}_{ij} + 1} , \\ \begin{matrix}else if {SD}_{ij} \geq {SD}_{tp} + \\ SC \& {ED}_{ij} \leq {ED}_{tp} + SC ,\end{matrix} & then {PR}_{ij} = 1 , \\ \begin{matrix}else if {SD}_{ij} \geq {SD}_{tp} + \\ SC \& {ED}_{ij} \geq {ED}_{tp} + SC ,\end{matrix} & then {PR}_{ij} = \frac{( {ED}_{tp} + SC ) - {SD}_{ij} + 1 )}{{ED}_{ij} - {SD}_{ij} + 1} ,\end{matrix}$$
wherein SDᵢⱼ is a start date of time interval i in fiscal period j, SDₜₚ is a start date of time interval t in fiscal period p, EDᵢⱼ is an end date of time interval i in fiscal period j, EDₜₚ is an end date of time interval t in fiscal period p, and SC is the sales cycle.

40. The method of claim 31, wherein generating the pipeline plan for one or more time periods comprises generating the pipeline plan in each of one or more dimensions for each of the one or more time periods.

41. The method of claim 40, wherein the one or more dimensions comprise go-to-market segments.

42. The method of claim 40, wherein the one or more dimensions comprise products.

43. A system comprising:
at least one hardware processor; and
one or more software modules that are configured to, when executed by the at least one hardware processor,
set a qualifying stage that divides a pipeline, comprising a plurality of stages, into an unqualified pipeline and a qualified pipeline,
set one or more times,
for each of the one or more times,
determine a set of opportunities that had reached the qualifying stage at that time,
calculate a metric of the qualified pipeline based on the determined set of opportunities, and
store the calculated metric in memory, and
perform one or more actions based on at least one of the stored calculated metrics.

44. A non-transitory computer-readable medium having instructions stored therein, wherein the instructions, when executed by a processor, cause the processor to:
set a qualifying stage that divides a pipeline, comprising a plurality of stages, into an unqualified pipeline and a qualified pipeline;
set one or more times;
for each of the one or more times,
determine a set of opportunities that had reached the qualifying stage at that time,
calculate a metric of the qualified pipeline based on the determined set of opportunities, and
store the calculated metric in memory; and
perform one or more actions based on at least one of the stored calculated metrics.
